(19) United States
(12) Patent Application Publication
(10) Pub. No.: US 2018/0273797 A1
(43) Pub. Date: Sep. 27, 2018

(54) COATED FILMS WITH PARTICULARLY HIGH RESISTANCE TO HYDROLYSIS, AND MOLDINGS MADE OF SAME

(71) Applicant: Covestro Deutschland AG, Leverkusen (DE)

(72) Inventors: Michael LUDEWIG, Odenthal (DE); Joachim PETZOLDT, Monheim (DE)

(73) Assignee: COVESTRO DEUTSCHLAND AG, Leverkusen (DE)

(21) Appl. No.: 15/760,422

(22) PCT Filed: Sep. 13, 2016
(86) PCT No.: PCT/EP2016/071573

§ 371 Date: Mar. 15, 2018

(30) Foreign Application Priority Data
Sep. 16, 2015 (EP) 15185390.0

(51) Int. Cl. C09D 175/16; C08J 7/04; C08G 18/67; C08G 18/44; C08G 18/76; C09D 7/61; B41M 1/30; B05D 1/40; B05D 3/02; B29C 51/14; B29C 51/42; B29C 35/08

(52) U.S. Cl. CPC C09D 175/16; B29K 2701/12; C08G 18/673; C08G 18/44; C08G 18/7671; C09D 7/61; B41M 1/30; B05D 1/40; B05D 3/0272; B29C 51/14; B29C 51/42; B29C 35/0805; C08J 2300/00; C08J 2475/16; C08J 7/047

(57) ABSTRACT

The present invention concerns coated films, comprising a plastic film and a radiation-curable aqueous coating material, wherein the coating material comprises a polyurethane (meth)acrylate with particularly high hydrolysis resistance. Furthermore, it concerns a method for producing such films, the use of such films for producing mouldings, a method for producing mouldings with a radiation-cured coating and mouldings that can be produced by this method and the aqueous radiation-curable binding and coating material, which are contained in the coating.

The present invention concerns coated films, comprising a plastic film and a radiation-curable aqueous coating material, wherein the coating material comprises a polyurethane (meth)acrylate with particularly high hydrolysis resistance. Furthermore, it concerns a method for producing such films, the use of such films for producing mouldings, a method for producing mouldings with a radiation-cured coating and mouldings that can be produced by this method and the aqueous radiation-curable binders and coating material, which are contained in the coating.

The curing of coating systems containing activated double bonds by actinic radiation is known and technically established. Actinic radiation is understood to include electromagnetic, ionising radiation, particularly electron beams, UV beams, as well as visible light (Roche Lexikon Medizin, 4th Edition; Urban & Fischer Verlag, Munich 1999). It is one of the fastest curing methods in coating technology. Coating materials based on this principle are designated, therefore, as beam- or actinic-curing or curable systems.

Aqueous, radiation-curable coating systems based on polyurethane polymers are used in the coating of, amongst other materials, wood, plastics and leather and are noted for a variety of positive properties, such as good chemical resistance and mechanic stability. In the main, these types of system contain no or very little organic solvents.

The use of aqueous, radiation-curable polyurethane polymers has also been established in the coating of plastic and film. In this process, good surface characteristics are generally achieved by the high cross-linking density of the coating. However, high cross-linking densities result in a duromer behaviour with just small maximum possible amounts of extension so that the coating tends to form cracks in a deformation process.

Methods have been proposed already, therefore, (WO-A 00/63015, WO-A 2005/080484, WO-A 2005/099943, WO-A 2005118689, WO-A 2006/048109, WO-A 2008/052665), in which, firstly, a polymeric component is applied to a ductile plastic film and is cured in a first step so that it is non-aligned. In a second step, the coated film is deformed before the coating is further cross-linked in third step by further curing by actinic radiation which provides the coating with its final good properties.

However, it has proved to be difficult in this process to develop coatings based on aqueous coating agents which maintain their high physical properties (media resistance and resistance to cracking), as well as retaining their adherence to the substrate under hydrolytic conditions at elevated temperatures. This type of property is desirable to prevent the failure of a coating in frequent physical contact or under tropical conditions.

DE-A 102010009896 discloses aqueous polyurethane dispersions based on epoxy acrylates and unsaturated polyesters. Systems such as these can also achieve very good hydrolysis resistances by their oxidative drying mechanism. However, in doing so, a longer drying time of a few days and the addition of siccatives are usually necessary. But neither is desirable in the film coating.

DE-A 102006051897 discloses printable films, a method for printing these films, the curing of layers to which printing inks are applied and mouldings made out of these. The printing inks disclosed in the examples as coating materials also contain a second cross linking mechanism (NCO—OH reaction). In this process, the formulation is provided with just a short pot life which means that it is necessary to formulate the printing ink immediately before applying it. But this necessitates working with binders which can be stored as long as desired.

Basically it is also known that paint based on radiation-curable polyurethane dispersions, which cross link only by radiation curing and which contain polycarbonate diols as substantial structural components, can achieve a particularly high hydrolysis and chemical resistance. Thus, just such a system is described in EP-A 1489120 whose main aim is to have a haptic surface. Despite this, a high chemical resistance and high hydrolytic stability are also mentioned.

Good weathering stability and chemical resistance are also claimed in WO-A 2006/101433 for very similar products based on radiation-curable polyurethane dispersions containing polycarbonate diols. It was shown that the claimed products are superior to those with polyethers regarding UV-stability and to those with polyesters regarding hydrolytic stability, which is less surprising. Both applications supply coatings with quite good chemical resistance and hydrolytic stability, but which need considerably more improvement for demanding applications such as for film coatings.

Therefore, it was a task of the present invention to provide coated films whose coating is block resistant and flexible in terms of physical drying and which, in terms of subsequent radiation curing, meet the highest demands regarding hydrolytic stability and chemical resistance, at the same time having excellent adherence to plastic films, preferably on plastic films based on polycarbonate and/or copolycarbonate.

According to the invention, a coated film is therefore proposed comprising a plastic film and a radiation-curable aqueous coating material, wherein the coating material comprises at least
a) a polyurethane (meth)acrylate, which can be obtained from the reaction of a reaction mixture comprising:
   A) one or more polyepoxy (meth)acrylates with a hydroxyl value of 20 to 300 mg KOH/g of substance, preferably of 100 to 280 mg KOH/g, particularly preferably 150 to 250 mg KOH/g,
   B) where applicable, different compounds from A) with at least one group reactive to isocyanate and at least one radiation-curable double bond,
   C) one or more linear aliphatic polycarbonate polyols with a hydroxyl value of 25 to 250 mg KOH/g of substance, preferably 35 to 160 mg KOH/g of substance and particularly preferably 50 to 100 mg KOH/g of substance,
   D) where applicable, one or more compounds having at least two groups reactive to isocyanate and a molecular weight of less than 300 g/mol, preferably of less than 200 g/mol, particularly preferably of less than 150 g/mol,
   E) one or more compounds with at least one group reactive to isocyanate and additionally at least one group with hydrophilic action,
   F) dicyclohexylmethane 4,4′-diisocyanate,
   G) where applicable, different compounds from A) to F) with at least one amino function,
   H) where applicable, reactive diluents with at least one radically polymerisable group, and
b) inorganic nanoparticles with a mean particle size from ≥1 nm to ≤200 nm, preferably from ≥3 nm to ≤50 nm, particularly preferably from ≥5 nm to ≤20 nm.

The component H) can also be included optionally in the coating material.

Within the scope of this invention, “(meth)acrylate” refers to acrylate or methacrylate functions or to a mixture of both.

The determination the hydroxyl value is done in accordance with DIN 53240.

In one embodiment of the invention, the radiation-curable aqueous coating material comprises the following components:
a) 8.0 to 65.0% w/w, preferably 10.0 to 40.0% w/w, particularly preferably 10.0 to 20.0% w/w of polyurethane (meth)acrylate,
b) 5.0 to 50.0% w/w, preferably 10.0 to 40.0% w/w, particularly preferably 15.0 to 35.0% w/w of inorganic nanoparticles,
c) 0 to 57.0% w/w, preferably 10.0 to 57.0% w/w, particularly preferably 37.0 to 47.0% w/w of polyurethane(meth)acrylate, different from a),
d) 0 to 30.0% w/w, preferably 0 to 20.0% w/w, particularly preferably 0 to 15.0% w/w of other binders or reactive diluents,
e) 0.1 to 5.0% w/w, preferably 02 to 4.0% w/w, particularly preferably 0.5 to 3.0% w/w of photoinitiators,
f) 0 to 15.0% w/w, preferably 0 to 10.0% w/w, particularly preferably 2.0 to 10.0% w/w of auxiliary and additional substances,
g) 0 to 10.0% w/w, preferably 0 to 5.0% w/w, particularly preferably 0% w/w of cross-linking agents,

wherein the quantity data refer to dried film and the sum of the individual components must add up to 100.

These types of coated films can be used, for example, for producing mouldings which have structural elements with very small bend radii. After curing by actinic radiation, the coatings have good abrasion resistance, good chemical resistance and high hydrolysis stability.

As well as having the required overall strength, the plastic film being used according to the invention has the necessary thermal ductility above all. The main examples of thermoplastic polymers that are particularly suitable include ABS, AMMA, ASA, CA, CAB, EP, UF, CF, MF, MPF, PF, PAN, PA, PE, HDPE, LDPE, LLDPE, PC, Co-PC, PET, PMMA, PP, PS, SB, PUR, PVC, RF, SAN, PBT, PPE, POM, PP-EPDM, and UP (abbreviations complying with DIN 7728T1) and the mixtures thereof, and compound films constructed with two or more layers of these plastics. Generally, the films used according to the invention also contain reinforcing fibres or tissues insofar as they do not impair the desired thermoplastic deformation.

Thermoplastic polyurethanes, polymethyl methacrylate (PMMA) as well as modified versions of PMMA, polycarbonate (PC), copolycarbonate (Co-PC), acrylonitrile styrene acrylate copolymer (ASA), acrylonitrile butadiene styrene copolymer (ABS) and polybutylene terephthalate/polycarbonate are particularly suitable.

The plastic film, or sheet also, is used preferably with a thickness from ≥50 μm to ≤1500 μm, particularly preferably from ≥100 μm to ≤1000 μm and quite particularly preferably from ≥150 μm to ≤750 μm. In addition, the material of the plastic film can contain additives and/or auxiliary process agents for making film, such as stabilisers, light stabilisers, plasticisers, fillers, such as fibres, and dyes. The side of the film provided for coating as well as the other side can be smooth or have a surface texture, wherein the side to be coated is preferably smooth.

In one embodiment, the plastic film can be a polycarbonate film, polybutylene terephthalate/polycarbonate film and/or a copolycarbonate film with a thickness from ≥50 μm to ≤1500 μm, preferably 100 μm to ≤1000 μm, particularly preferably ≥150 μm to ≤750 μm, wherein the additives and/or auxiliary process agents mentioned above are included.

The inventive coated film can be coated on one or both sides, wherein coating on one side is preferred. In the case of one one-sided coating, as an option a thermally deformable adhesive layer can be applied to the reverse side of the film, that is, on the surface on which the coating material has not been applied. In this case, depending on the method used, preferably hot melt adhesives or radiation-curing adhesives are suitable. In addition, a protective film can also be applied to the surface of the adhesive layer which is also thermally deformable. Furthermore, it is possible to provide the reverse side of the film with support materials, such as fabrics but which should be deformable to the desired extent.

Optionally, before or after the application of the coating material containing at least one polyurethane (meth)acrylate a), the plastic film can be painted or printed with one or more layers. This can be done on the coated or on the uncoated side of the film. The layers can provide a colour or a function, applied across the whole surface or only partially, such as a printed image. The paint used should be thermoplastic so that is will not crack with subsequent deformation. Printing inks, such as those commercially obtainable for the so-called “in-mould decoration” process, can be used.

The radiation-curable coating of the plastic film may later represent the surface of everyday objects. According to the invention, provision is made that the coating contains at least one polyurethane (meth)acrylate a).

The aqueous radiation-curable coating material is used preferably as a 20 to 60%, particularly preferably as a 30-58% aqueous dispersion. Aqueous dispersions offer the advantage also of processing particularly high molecular polyurethanes in a coating material with low dynamic viscosity since, with dispersions, the viscosity is independent of the molecular weight of the components of the dispersed phase.

The individual components of the polyurethane (meth)acrylate a) are described below in more detail and which is included in the aqueous radiation-curable coating material.

Structural component A) and, where applicable, components B) and (H) are used in this case in quantities whereby the content of radiation-curable double bonds in the polyurethane (meth)acrylate a) comes to between 0.5 and 6.0 mol/kg, preferably between 0.7 and 5.0 mol/kg, particularly preferably between 1.0 and 3.0 mol/kg of the non-aqueous constituent parts of the dispersion.

Component A) is used in quantities of 5 to 45% w/w, preferably 10 to 40% w/w, particularly preferably 15 to 30% w/w in relation to the total of components A) to H).

Component B), insofar as it is co-utilised, is used in quantities of 1 to 30% w/w in relation to the total of components A) to H). Co-utilisation of component B) is not preferable.

Component C) is used in quantities of 15 to 65% w/w, preferably 20 to 60% w/w, particularly preferably 25 to 55% w/w in relation to the total of components A) to H).

Component D), insofar as it is co-utilised, is used in quantities of 1 to 10% w/w in relation to the total of components A) to H).

Component E) is used in quantities of 1 to 20% w/w, preferably 1 to 10% w/w particularly preferably 1 to 5% w/w, in relation to the total of components A) to H).

Component F) is used in quantities of 10 to 65% w/w, preferably 15 to 50% w/w, particularly preferably 20 to 30% w/w, in relation to the total of components A) to H).

Component G) insofar as it is co-utilised, is used in quantities 1 to 15% w/w, preferably 2 to 10% w/w, particularly preferably 3 to 7% w/w, in relation to the total of components A) to H).

Component H) insofar as it is co-utilised, is used in quantities 1 to 40% w/w, preferably 10 to 30% w/w, in relation to the total of components A) to H), wherein the component H) can also be added optionally to the coating material.

Substances suitable as component A) are the known polyepoxy (meth)acrylates containing hydroxyl groups with a hydroxyl value in the range from 20 to 300 mg KOH/g, preferably from 100 to 280 mg KOH/g, particularly preferably from 150 to 250 mg KOH/g. These types of compounds are described on pages 37 to 56 in P. K. T. Oldring (Ed.), Chemistry & Technology of UV & EB Formulations For Coatings, Inks & Paints, Vol. 2, 1991, SITA Technology, London. Aromatic, polyepoxy (meth)acrylates containing hydroxyl groups are based on reaction products of acrylic acid and/or methacrylic acid with aromatic or aliphatic glycidyl ethers (epoxides), preferably aromatic glycidyl ethers of monomeric, oligomeric or polymeric bisphenol-a and/or bisphenol-f or alkoxylated derivates thereof. The reaction product of acrylic acid with the glycidyl ether of bisphenol-a is particularly preferred as component A).

The compounds listed under component A) can be used as such by themselves or in mixtures.

Optional component B) contains one or more compounds selected from the group consisting of polyester (meth)acrylates, polyether (meth)acrylates, polyether ester (meth)acrylates and unsaturated polyesters with allyl ether structural units with a hydroxyl value in the range from 15 to 300 mg KOH/g of substance and monohydroxy-functional alcohols containing (meth)acrylate groups

In terms of polyester (meth)acrylates, those used as component B) are the polyester (meth)acrylates containing hydroxyl groups with a hydroxyl value in the range from 15 to 300 mg KOH/g of substance, preferably from 60 to 200 mg KOH/g of substance. When producing the hydroxy functional polyester (meth)acrylates as component B), a total of 7 groups of monomeric constituent parts can be used:

The first group (a) contains alkane diols or diols or mixtures thereof. The alkane diols have a molecular weight in the range from 62 to 286 g/mol. The preferred alkane diols are selected from the group consisting of ethanediol, 1,2- and 1,3-propanediol, 1,2-, 1,3- and 1,4-butanediol, 1,5-pentanediol, 1,6-hexanediol, neopentyl glycol, cyclohexane-1,4-dimethanol, 1,2- and 1,4-cyclohexanediol, 2-ethyl-2-butylpropanediol. Preferred diols are those containing etheric oxygen, such as diethylene glycol, triethylene glycol, tetraethylene glycol, dipropylene glycol, tripropylene glycol, polyethylene-, polypropylene- or polybutylene glycols with a number average of the molar mass Mn in the range from 200 to 4000, preferably 300 to 2000, particularly preferably 450 to 1200 g/mol. Reaction products of the diols listed above with i-caprolactone or other lactones can also be used as diols.

The second group (b) contains three- and higher value alcohols with a molecular weight in the range from 92 to 254 g/mol and/or polyethers started with these alcohols. Particularly preferable three- and higher value alcohols are glycerine, trimethylolpropane, pentaerythritol, dipentaerythritol and sorbitol. A particularly preferable polyether is the reaction product of 1 mol of trimethylolpropane with 4 mols of ethylene oxide.

The third group (c) contains monoalcohols. Particularly preferable monoalcohols are selected from the group consisting of ethanol, 1- and 2-propanol, 1- and 2-butanol, 1-hexanol, 2-ethylhexanol, cyclohexanol and benzyl alcohol.

The fourth group (d) contains dicarbonic acids with a molecular weight in the range from 104 to 600 g/mol and/or their anhydrides. Preferred dicarbonic acids and their anhydrides are selected from the group consisting of phthalic acid, phthalic acid anhydride, isophthalic acid, tetrahydrophthalic acid, tetrahydrophthalic acid anhydride, hexahydrophthalic acid, hexahydrophthalic acid anhydride, cyclohexane dicarbonic acid, maleic acid anhydride, fumaric acid, malonic acid, bernstein acid, bernstein acid anhydride, glutaric acid, adipic acid, pimelic acid, cork acid, sebacic acid, dodecanoic acid, hydrated dimers of fatty acids, such as those listed under the sixth group (f).

The fifth group (e) contains trimellitic acid or trimellitic acid anhydride.

The sixth group (f) contains monocarbonic acids, such as benzoic acid, cyclohexane carbonic acid, 2-ethylhexane acid, caproic acid, caprylic acid, caprinic acid, lauric acid, and natural and synthetic fatty acids, such as lauric-, myristic-, palmitic-, margaric-, stearic-, behenic-, cerotic-, palmitoleic-, oleic-, eicosenic-, linoleic-, linolnic- and arachidonic acid.

The seventh group (g) contains acrylic acid, methacrylic acid and/or dimeric acrylic acid.

Suitable polyester (meth)acrylates B) containing hydroxyl groups contain the reaction product of at least one constituent part from group (a) or (b) with at least one constituent part from group (d) or (e) and at least one constituent part from group (g).

Particularly preferable constituent parts from the group (a) are selected from the group consisting of ethanediol, 1,2- and 1,3-propanediol, 1,4-butanediol, 1,6-hexanediol, neopentyl glycol, cyclohexane-1,4-dimethanol, 1,2- and 1,4-cyclohexanediol, 2-ethyl-2-butylpropene diol, diols containing etheric oxygen, selected from the group consisting of diethylene glycol, triethylene glycol, tetraethylene glycol, dipropylene glycol, and tripropylene glycol. Preferred constituent parts from the group (b) are selected from the group consisting of glycerine, trimethylolpropane, pentaerythritol or the reaction product of 1 mol of trimethylolpropene with 4 mol of ethylene oxide. Particularly preferable constituent parts from the groups (d) and/or (e) are selected from the group consisting of phthalic acid anhydride, isophthalic acid, tetrahydrophthalic acid anhydride, hexahydrophthalic acid, hexahydrophthalic acid anhydride, maleic acid anhydride, fumaric acid, bernstein acid anhydride, glutaric acid, adipic acid, dodecanoic acid, hydrated dimers of fatty acids, such as those listed under the sixth group (f) and trimellitic acid anhydride. The preferred constituent part from the group (g) is acrylic acid.

If necessary, generally known from prior art, dispersant groups can also be incorporated into these polyester (meth)acrylates. Thus, polyethylene glycols and/or methoxypolyethylene glycols can be used proportionately as an alcohol component. Polyethylene glycols, polypropylene glycols and their block copolymers started from alcohols, as well as the monomethyl ethers of these polyglycols can be used as compounds. Polyethylene glycol mono-methyl ether with a number average of the molar mass Mn in the range from 500 to 1500 g/mol is particularly suitable.

Furthermore, it is possible after esterification, to react a part of the still free, non-esterified carboxylic groups, in particular those of the (meth)acryl acid, with mono-, di- or polyepoxides. Those preferred epoxides are the glycidyl ethers of monomeric, oligomeric or polymeric bisphenol-a, bisphenol-f, hexane diol and/or butane diol or their ethoxylated and/or propoxylated derivates. This reaction can be used in particular to increase the hydroxyl value of the polyester (meth)acrylate since an OH-group appears in each case in the epoxide acid reaction. The acid number of the resulting product lies between 0 and 20 mg KOH/g, preferably between 0 and 10 mg KOH/g and particularly preferably between 0 and 5 mg KOH/g of substance. The reaction is preferably catalysed by catalysts such as triphenylphosphine, thiodiglycol, ammonium- and/or phosphonium halides and/or zirconium- or tin compounds such as tin(ii)ethylhexanoate.

The production of polyester (meth)acrylates is described on page 3, line 25 to page 6, line 24 of DE-A 4 040 290, on page 5, line 14 to page 11, line 30 of DE-A 3 316 592 and page 123 to 135 of P. K. T. Oldring (Ed.) in Chemistry & Technology of UV & EB Formulations For Coatings, Inks & Paints, Vol. 2, 1991, SITA Technology, London.

Polyether (meth)acrylates containing hydroxyl groups are suitable, furthermore, as component B), which are produced in the reaction of acryl acid and/or methacrylic acid with polyethers, such as homo-, co- or block copolymerisates of ethylene oxide, propylene oxide and/or tetrahydrofuran on any hydroxy- and/or amino functional starter molecules, such as trimethylolpropane, ethylene glycol, propylene glycol, diethylene glycol, dipropylene glycol, glycerine, pentaerythritol, neopentyl glycol, butane diol and hexane diol.

Furthermore, monohydroxy functional alcohols, containing (meth)acrylate groups are suitable as component B), such as 2-hydroxyethyl (meth)acrylate, caprolactone-extended modifications of 2-hydroxyethyl (meth)acrylate such as Pemcure12A (Cognis, DE), 2-hydroxypropyl (meth)acrylate, 4-hydroxybutyl (meth)acrylate, 3-hydroxy-2,2-dimethylpropyl (meth)acrylate, the polyvalent alcohols, in monohydroxy functional di-, tri or penta(meth)acrylates, such as trimethylolpropene, glycerine, pentaerythritol, ditrimethylolpropane, dipentaerythritol, ethoxylated, propoxylated or alkoxylated trimethylolpropane, glycerine, pentaerythritol, ditrimethylolpropane, dipentaerythritol or technical mixtures thereof.

In addition, the reaction products of (meth)acrylic acids with, where applicable, monomeric epoxide compounds having double bonds can also be used as monohydroxy functional alcohols containing (meth)acrylate groups. Preferred reaction products are selected from the group consisting of (meth)acrylic acid with glycidyl (meth)acrylate or the glycidyl esters of tertiary, saturated monocarbonic acid. Tertiary, saturated monocarbonic acids include, for example, 2.2-dimethylbutter acid, ethyl methylbutter-, ethyl methylpentane-, ethyl methylhexane-, ethyl methylheptane- and/or ethyl methyloctane acid.

Preferred compounds containing unsaturated groups are selected from the group of polyester (meth)acrylates, polyether (meth)acrylates, 2-hydroxyethyl (meth)ecrylate, 2-hydroxypropyl (meth)acrylate, pentaerythritic triacrylate, dipentaerythritic pentaacrylate and the addition product from ethyl methylheptane acid glycidyl ester with (meth)acryl acid and technical mixtures thereof.

The compounds listed under component B) can be used by themselves or in mixtures also. The use of component B) is not preferred.

As component C), polycarbonate polyols with a hydroxyl value of 25 to 250 mg KOH/g of substance, preferably 35 to 160 and particularly preferably 50 to 100 mg KOH/g of substance, are used.

The functionality of the polycarbonate polyols that can be used according to the invention falls, in one embodiment, between 1.8 and 3.2, preferably between 1.9 and 2.5 and particularly preferably between 1.95 and 2.1.

The functionality of the polycarbonate polyols stems from the polyols used for the production and the method familiar to the expert in determining the termination reactions, such as by using NMR spectroscopy.

Polycarbonate polyols are polyesters from carbonic acid and polyols which are produced by transesterification of carbonic acid derivatives such as diphenyl carbonate, dimethyl carbonate or diethyl carbonate with polyols. The polycarbonate polyols usable according to the invention are constructed substantially from linear, aliphatic diols, such as 1,2-ethanediol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol. Preferably, the polycarbonate polyols usable according to the invention are constructed substantially from 1,4-butanediol, 1,5-pentanediol and/or 1.6-hexanediol; the particularly preferable construction is from 1,6-hexanediol.

Subordinated quantities (up to 10 mol-% relative to the linear aliphatic diols) of other polyols can also co-utilised to construct the polycarbonate polyol, such as 1,2-propanediol, neopentyl glycol, 2-ethyl-2-butylpropanediol, trimethyl pentanediol, 1,4-cyclohexane dimethanol, 1,2- and 1,4-cyclohexanediol, hydrated bisphenol a (2,2-bis(4-hydroxycyclohexyl)propane), diols derived from dimer fatty acids, 2,2-dimethyl-3-hydroxypropionic acid-(2,2-dimethyl-3-hydroxypropyl ester), glycerine, trimethylolethane, trimethylolpropene, trimethylolbutane and/or castor oil. However, co-utilisation of such polyols is not preferable.

The optional component D) contains monomeric di- and/or triols, respectively with a molecular weight of 32 to 300 g/mol, such as ethylene glycol, diethylene glycol, triethylene glycol, tetraethylene glycol, dipropylene glycol, tripropylene glycol, 1,2-propanediol, 1,3-propenediol, 1,4-butanediol, neopentyl glycol, 2-ethyl-2-butylpropanediol, trimethylpentanediol, 1,3-butylene glycol, 1,4-cyclohexanedimethanol, 1,6-hexanediol, 1,2- and 1,4-cyclohexanediol, hydrated bisphenol A (2,2-bis(4-hydroxycyclohexyl)propane), diols derived from dimer fatty acids, 2,2-dimethyl-3-hydoxypropionic acid-(2,2-dimethyl-3-hydroxypropyl ester), glycerine, trimethylolethane, trimethylolpropane, trimethylolbutane and/or castor oil. Neopentyl glycol, 1,4-butanediol, 1,4-cyclohexanedimethanol, 1,6-hexanediol and/or trimethylolpropane are preferred.

Component E) comprises compounds with at least one group reactive to isocyanate and, in addition, at least one group with hydrophilic action.

The groups with hydrophilic action include ionic groups E1) and/or the ionic groups E1) resulting (for example, by salification) from potential ionic groups E2) which can be anionic in nature E1.1) such as sulfonium-, phosphonium-, carboxylate-, sulfonate-, phosphonate groups or cationic in nature E1.2) such as ammonium groups, potentially ionic groups E2), i.e. groups which, for example, can be converted by salification into ionic groups E1) and/or non-ionic groups E3) such as polyether groups which can be constructed by isocyanate-reactive groups in the macromolecules. The preferred suitable isocyanate-reactive groups are hydroxyl- and amino groups.

Compounds containing potentially ionic groups E2) comprise compounds with potentially anionic groups E2.1) such as mono- and dihydroxycarbonic acids, mono- and diaminocarbonic acids, mono- and dihydroxysulfonic acids, mono- and diaminosulfonic acids, mono- and dihydroxyphosphonic acids, mono- and diaminophosphonic acids and/or compounds with potentially cationic groups E2.2) such as ethanolamine, diethanolamine, triethanolamine, 2-propenolamine, dipropanolamine, tripropanolamine, n-methylethanolamine, n-methyl-diethanolamine and n,n-dimethylethanolamine.

Preferred compounds containing potentially anionic groups E2.1) are selected from the group consisting of dimethylol propionic acid, dimethylolbutter acid, hydroxy pivalic acid, n-(2-amino-ethyl)-alanine, 2-(2-amino-ethylamino)-ethanesulfonic acid, ethylene-diamine-propyl- or -butylsulfonic acid, 1,2- or 1,3-propylene diamine-ethyl sulfonic acid, 3-(cyclohexylamino)propane-1-sulfonic acid, malic acid, citric acid, glycolic acid, lactic acid, glycine, alanine, taurine, lysine, 3,5-diaminobenzoic acid, an addition product of isophorone diamine (I-amino-3,3,5-trimethyl-5-aminomethyl cyclohexane, IPDA) and acrylic acid (EP-A 916 647, Example 1), the adduct of sodium bisulfite on butene-2-diol-1,4-polyethersulfonate and the propoxylated adduct from 2-butenediol and NaHSO₃, as described in DE A 2 446 440 on page 5-9, Formulae I-III.

Particularly preferably compounds containing potentially ionic groups E2) are carboxyl groups, sulfonic acid groups and/or tertiary amino groups containing compounds such as 2-(2-amino-ethylamino-)ethanesulfonic acid, 3-(cyclohexylamino)propane-1-sulfonic acid, the addition product of isophorone diamine and acrylic acid (EP 916 647 A1, Example 1), hydroxypivalic acid, dimethylol propionic acid, triethanolamine, tripropenolamine, n-methyldiethanolamine and/or n,n-dimethylyleanolamine.

Quite particularly preferably, component E) contains hydroxypivalic acid and/or dimethylol propionic acid as compounds with potentially ionic groups.

Suitable non-ionic groups E3) with hydrophilic action are, for example, polyalkylene oxide ethers containing at least one hydroxy- or amino group, and one or more alkylene oxide units of which at least one is an ethylene oxide unit. These polyalkylene oxide ethers are obtainable in a generally known manner by alkoxylation of suitable starter molecules.

Examples of starter molecules are saturated monoalcohols such as methanol, ethanol, n-propanol, isopropanol, n-butanol, isobutanol, sec-butanol, the isomers pentanols, hexanols, octanols and nonanols, n-decanol, n-dodecanol, n-tetradecanol, n-hexadecanol, n-octadecanol, cyclohexanol, the isomers methylcyclohexanols or hydroxymethyl cyclohexane, 3 ethyl-3-hydroxymethyl oxetane or tetrahydrofurfuryl alcohol, diethylene glycol monoalkyl ethers such as diethylene glycol monobutyl ether, unsaturated alcohols such as allyl alcohol, 1,1-dimethylallyl alcohol or oleic alcohol, aromatic alcohols such as phenol, the isomers of cresols or methoxyphenols, araliphatic alcohols such as benzyl alcohol, anise alcohol or cinnamic alcohol, secondary monoaemines such as dimethylamine, diethylamine, dipropylamine, diisopropylamine, dibutylamine, bis-(2-ethylhexyl)-amine, n-methyl- and n-ethyl cyclohexylamine or dicyclohexylamine and heterocyclic secondary amines such as morpholine, pyrrolidine, piperidine or 1h-pyrazole. Trimethylolpropane, which is just alkoxylated to an OH-group, is also suitable. Preferred starter molecules are saturated monoalcohols and trimethylolpropane, which is just alkoxylated to an OH-group. Particularly preferably, diethylene glycol monobutyl ether is used as a starter molecule.

Examples of alkylene oxides suitable for the alkoxylation reaction are ethylene oxide, 1-butene oxide and propylene oxide, which can be used in any sequence or in the mixture also during the alkoxylation reaction.

The polyalkylene oxide polyether alcohols involve either purely polyethylene oxide polyethers or mixed polyalkylene oxide polyethers, whose alkylene oxide units comprise up to at least 30 mol-%, preferably up to at least 40 mol-% of ethylene oxide units. Preferred non-ionic compounds are monofunctional mixed polyalkylene oxide polyethers, which have at least 40 mol-% of ethylene oxide- and a maximum of 60 mol-% of propylene oxide units. Also preferable are polyalkylene oxides, started with trimethylolpropne, with an OH-functionality of 2, such as Tegomer® D 3403 (Evonik Industries AG, Essen, DE) and Ymer® N 120 (Perstorp AB, Sweden).

The acids listed under component E2.1) can be converted by reacting with neutralisers, such as triethylamine, ethyl diisopropylamine, dimethylcyclohexylamine, dimethylethanolamine, n,n-dimethylethylamine, ammonia, n-ethylmorpholine, LiOH, NaOH and/or KOH in the corresponding salts. The degree of neutralisation in this process falls preferably between 50 and 125%. The degree of neutralisation is defined as follows: for acid-functionalised polymers as the quotient of base and acid; for base-functionalised polymers as the quotient of acid and base. If the neutralisation falls above 100%, for acid-functionalised polymers, more base than acid groups are present in the polymer, for base-functionalised polymers, more acid than base groups are present in the polymer.

The bases listed under component E2.2) can be converted by reacting with neutralisers, such as inorganic acids, such as hydrochloric acid, phosphoric acid and/or sulphuric acid, and/or organic acids, which include formic acid, acetic acid, lactic acid, methane-, ethane- and/or p-toluolsulfonic acid, in the corresponding salts. The degree of neutralisation falls preferably between 50 and 125% in this process.

The compounds listed under component E) can also be used in mixtures.

The ionic hydrophilation and the combination of ionic and non-ionic hydrophilation are preferable as against purely non-ionic hydrophilation. Ionic hydrophilation is particularly preferable.

Dicyclohexylmethane 4,4′-diisocyanate is used as component F).

In order to increase the weight average of the molecular weight M_{w} of the polyurethane (meth)acrylates a), mono- and diamines and/or mono- or difunctional amino alcohols can be used as optional component G). Preferred diamines are those that are more reactive than water compared with the isocyanate groups, since the lengthening of the polyurethane (meth)acrylate takes place where applicable in the aqueous medium. The diamines are particularly preferable selected from the group consisting of ethylene diamine, 1,6-hexamethylene diamine, isophorone diamine, 1,3-phenylene diamine, 1,4-phenylene diamine, piperazine, 4,4′-diphenyl methane diamine, aminofunctional polyethylene oxides, aminofunctional polypropylene oxides (known under the names Jeffamin® d series (Huntsman Corp. Europe, Zavantem, Belgium) and Hydrazin. Ethylene diamine is quite particularly preferable.

Preferred monoamines are selected from the group consisting of butylamine, ethylamine and amine in the Jeffamin® m series (Huntsman Corp. Europe, Zavantem, Belgium), aminofunctional polyethylene oxides, aminofunctional polypropylene oxides and/or amino alcohols.

The optional components H) are reactive diluents, whose compounds are understood to include at least one radically polymerisable group, preferably acrylate- and methacrylate groups, and preferably contain no groups reactive with isocyanate- or hydroxy groups.

Preferred compounds H) have 2 to 6, particularly preferably 4 to 6 (meth)acrylate groups. Particularly preferred compounds H) have a boiling point over 200° C. at normal pressure.

Reactive diluents are described generally in P. K. T. Oldring (Ed.), Chemistry & Technology of UV & EB Formulations for Coatings, Inks & Paints, Vo. II, Chapter III: Reactive Diluents for UV & EB Curable Formulations, Wiley and SITA Technology, London 1997.

Reactive diluents are, for example, these alcohols completely esterified with (meth)acrylic acid, such as methanol, ethanol, 1-propenol, 1-butanol, 1-pentanol, I-hexanol, 2-propanol, 2-butanol, 2-ethylhexanol, dihydro dicyclopentadienol, tetrahydro furfuryl alcohol, 3,3,5-trimethylhexanol, octanol, decanol, dodecanol, ethylene glycol, diethylene glycol, triethylene glycol, tetraethylene glycol, dipropylene glycol, tripropylene glycol, 1,2-propanediol, 1,3-propanediol, 1,4-butanediol, neopentyl glycol, 2-ethyl-2-butylpropanediol, trimethylpentanediol, 1,3-butylene glycol, 1,4-cyclohexanedimethanol, 1,6-hexanediol, 1,2- and 1,4-cyclohexanediol, hydrated bisphenol a (2,2-bis(4-hydroxy cyclohexyl)propene), tricyclodecane dimethanol, glycerine, trimethylolethane, trimethylolpropene, trimethylolbutane, pentaerythritol, ditrimethylolpropane, dipentaerythritol, sorbitol and ethoxylated and/or propoxylated derivates of the listed alcohols and the technical mixtures occurring in the (meth)acrylation of the named compounds.

Component H) is preferably selected from the group of (meth)acrylates of tetrols and hexols, such as (meth)acrylates of pentaerythritol, ditrimethylolpropane, dipentaerythritol, sorbitol, ethoxylated, propoxylated or alkoxylated pentaerythritol, ditrimethylolpropane, dipentaerythritol, sorbitol and ethoxylated and/or propoxylated derivatives of the listed alcohols and the technical mixtures occurring in the (meth)acrylation of the named compounds.

The component H) which is particularly preferred is selected from the group of acrylates of pentaerythritol, ditrimethylolpropane and dipentaerythritol and the technical mixtures occurring in the acrylation of the compounds named above, and the acrylate of dipentaerythritol is quite particularly preferred.

The compounds H) serve to increase the double bond density of the coating medium. A high double bond density raises the usage properties (resistance to mechanical or chemical effects) of the UV-cured coating. Also they affect the drying properties. Therefore, preferably ≥1% w/w to ≤30% w/w, in particular ≥5% w/w to ≤25% w/w and very particularly preferably ≥5% w/w to ≤20% w/w relative to the total solid body of the coating agent is used.

The inorganic nanoparticles b) worth considering in the coating material are inorganic oxides, micoxides, hydroxides, sulfates, carbonates, carbides, borides and nitrides of elements in the II to IV main group and/or elements in the I to VIII subgroup of the periodic system including the lanthanides. Preferred particles are those from silicon oxide, aluminium oxide, ceroxid, zirconium oxide, niobium oxide and titanium oxide, of which silicon oxide nanoparticles are particularly preferable.

The particles used have mean particle sizes from ≥1 nm to ≤200 nm, preferably from ≥≥3 nm to ≤50 nm, particularly preferably from ≥5 nm to ≤20 nm. The mean particle size can be determined preferably as the mean z score by means of dynamic light scatter in dispersion. Below 1 nm of particle size, the nanoparticles reach the size of the polymer particle. Nanoparticles this small can cause the viscosity of the coating to rise which is disadvantageous. Above 200 nm in particle size, the particles can be made out with the naked eye, which is not desired.

Preferably ≥75%, particularly preferably ≥90%, quite particularly preferably ≥95% of all particles used have the sizes defined above. As the number of coarse particles increases in the total mass of particles, the optical properties worsen and clouding in particular can occur.

The particles can be selected such that the refractive index of their material corresponds to the refractive index of the hardened radiation-curable coating. Then, the coating has transparent optical properties. For example, a refractive index in the range from ≥135 to ≤1.46 is advantageous.

In a further embodiment, the surface of the nanoparticles in the coating is modified by the covalent and/or non-covalent linking of other compounds.

A preferable covalent surface modification is silanisation with alkoxy silanes and/or chlorosilanes. The partial modification with γ-glycidoxypropyltrimethoxysilane is particularly preferable.

An example of a non-covalent case is an adsorptive/associative modification by tensides or block copolymers.

Furthermore, it is possible that the compounds, which are bound to the surface of the nanoparticles covalently and/or non-covalently, also contain carbon-carbon double bonds. In this case, (meth)acrylate groups are preferred. In this manner, the nanoparticles can be bound in even faster during the radiation curing in the binder matrix.

In a preferred embodiment, besides the polyurethane (meth)acrylate a), the radiation-curable aqueous coating material comprises a further polyurethane (meth)acrylate c), which differs from a).

Preferably, the polyurethane (meth)acrylate c) comprises the following components:
B-1) compounds comprising (meth)acrylate groups and reactive to isocyanates,
C-1) where applicable, polyol compounds with a hydroxyl value from 10 mg KOH/g to 500 mg KOH/g, preferably from 28 mg KOH/g to 256 mg KOH/g, particularly preferably from 35 mg KOH/g to 128 mg KOH/g
D-1) where applicable, polyol compounds with a molecular weight from 50 g/mol to 500 g/mol,
E-1) one or more compounds with at least one group reactive to isocyanates and additionally at least one group with hydrophilic action,
G-1) where applicable, compounds with at least one amine function and differing from B1, D1, E1,
F-1) polyisocyanates,
H-1) where applicable, reactive diluents, which have at least one radically polymerisable group.

Component B-1) comprises those compounds which were described above already under A) and/or B).

Suitable higher molecular polyols C-1) are polyols (which are also to include diols) with a hydroxyl value in the range from 10 mg KOH/g to 500 mg KOH/g, preferably from 28 mg KOH/g to 256 mg KOH/g, particularly preferably from 35 mg KOH/g to 128 mg KOH/. Preferably polymers are used with a mean hydroxyl functionality from ≥1.5 to ≤2.5, preferably from ≥1.8 to ≤2.2, particularly preferably from ≥1.9 to ≤2.1. These include, for example, polyester alcohols based on aliphatic, cycloaliphatic and/or aromatic di-, tri- and/or polycarbonic acids with di-, tri-, and/or polyols and polyester alcohols based on lactone. Preferred polyester alcohols are, for example, reaction products of adipinic acid with hexane diol, butane diol or neopentyl glycol or mixtures of the quoted diols. Polyetherols are also suitable which are obtainable by polymerisation of cyclic ethers or by reacting alkylene oxides with a starter molecule. Examples include the polyethylene- and/or polypropylene glycols with a hydroxyl value in the range from 10 mg KOH/g to 500 mg KOH/g, preferably from 28 mg KOH/g to 256 mg KOH/g, particularly preferably from 35 mg KOH/g to 128 mg KOH/g, as well as polytetrahydrofurans with a mean molecular weight from ≥500 g/mol to ≤8000 g/mol, preferably from ≥800 g/mol to ≤3000 g/mol.

Hydroxyl-terminated polycarbonates are also suitable which can be obtained by reacting diols or also lactone-modified diols or also bisphenols, such as, bisphenol a, with phosgene or carbonic acid diesters such as diphenyl carbonate or dimethyl carbonate. Examples which can be quoted are the polymeric carbonates of the 1,6-hexanediols with a hydroxyl value from 10 mg KOH/g to 256 mg KOH/g, and the carbonates of reaction products of the 1,6-hexanediols with c-caprolactone in a molar relationship from ≥0.1 to ≤1. The polycarbonatediols named above are preferred with a hydroxyl value from 28 mg KOH/g to 256 mg KOH/g based on 1,6-hexanediol and/or carbonates of reaction products of the 1,6-hexanediols with ε-caprolactone in a molar relationship from ≥0.33 to ≤1. Hydroxyl-terminated polyamide alcohols and hydroxyl-terminated polyacrylatediols can also be used.

Suitable low molecular polyols D-1) are short-chained, preferably aliphatic, araliphatic or cycloaliphatic diols or triols containing ≥2 to ≤20 carbon atoms. Examples for diols include ethylene glycol, diethylene glycol, triethylene glycol, tetraethylene glycol, dipropylene glycol, tripropylene glycol, 1,2-propanediol, 1,3-propanediol, 1,4-butanediol, neopentyl glycol, 2-ethyl-2-butylpropanediol, trimethylpentanediol, positional isomeric diethyloctanediols, 1,3-butylene glycol, cyclohexanediol, 1,4-cyclohexanedimethanol, 1,6-hexanediol, 1,2- and 1,4-cyclohexanediol, hydrated bisphenol a (2,2-bis(4-hydroxycyclohexyl)propane), 2,2-dimethyl-3-hydroxypropionic acid-(2,2-dimethyl-3-hydroxypropylester). 1,4-butanediol, 1,4-cyclohexanedimethanol and 1,6-hexanediol are preferred. Examples of suitable triols are trimethylolethane, trimethylolpropane or glycerine, of which trimethylolpropane is preferred.

Component E-1) comprises those compounds which were described above already under E).

Polyisocyanates (F-1) which are suitable, and which are understood to also include diisocyanates, are aromatic, araliphatic, aliphatic or cycloaliphatic polyisocyanates. Mixtures of these types of di- or polyisocyanates can also be used. Examples of suitable polyisocyanates include butylene diisocyanate, hexamethylene diisocyanate (HDI), isophorone diisocyanate (IPDI), 2,2,4 and/or 2,4,4-trimethylhexamethylene diisocyanate, bis(4,4′-isocyanatocyclo-hexyl)methane, isocyanatomethyl-1,8-octane diisocyanate, 1,4-cyclohexylene diisocyanate, 1,4-phenylene diisocyanate, 2,4- and/or 2,6-toluene diisocyanate, the isomers xylene diisocyanates, 1,5-naphthylene diisocyanate, 2,4′- or 4,4′-diphenylmethane diisocyanate, triphenylmethane-4,4′,4″-triisocyanate or their derivatives with urethane-, isocyanurate-, allophanate-, biuret-, oxadiazine trione-, uretdione-, iminooxadiazine diol structure and mixtures thereof. Di- or polyisocyanates with cycloaliphatic or aromatic structure are preferred since a higher proportion of these structural elements has a positive influence on the drying properties, particularly the block resistance of the coating before the UV curing. Isophorone diisocyanate and bis(4,4′-iso-cyanatocyclohexyl)methane and mixtures thereof are particularly preferable diisocyanates.

Component G-1) comprises those compounds which were described above already under G).

Component H-1) comprises those compounds which were described above already under H).

In one embodiment, the components B-1) to H-1) can be present in the polyurethane (meth)acrylates c) in the following quantities, wherein the sum of the individual weight fractions totals 100:

B-1): ≥10% w/w to ≤80% w/w, preferably ≥30% w/w to ≤60% w/w, particularly preferably ≥40% w/w to ≤50% w/w.

C-1): ≥0% w/w to 50% w/w, preferably 0% w/w to 30% w/w, particularly preferably 0% w/w.

D-1): ≥0% w/w to ≤25% w/w, preferably ≥0.5% w/w to 15% w/w, particularly preferably ≥1% w/w to ≤5% w/w.

E-1): ≥1% w/w to ≤20% w/w, preferably ≥2% w/w to ≤15% w/w, particularly preferably 3% w/w to ≤10% w/w.

F-1): ≥5% w/w to 50% w/w, preferably ≥20% w/w to ≤40% w/w, particularly preferably ≥25% w/w to ≤35% w/w.

G-1): ≥0% w/w to 5 20% w/w, preferably ≥0.5% w/w to ≤10% w/w, particularly preferably ≥1% w/w to ≤5% w/w.

H-1): ≥0% w/w to ≤40% w/w, preferably ≥5% w/w to 5 30% w/w, particularly preferably ≥5% w/w to ≤25% w/w.

Component d) can comprise other binders, preferably dispersions which also contain unsaturated groups, such as unsaturated dispersions containing polymerisable groups based on polyesters, polyurethanes, polyepoxy(meth)acrylates, polyethers, polyamides, polysiloxanes, polycarbonates, polyepoxy(meth)acrylates, polyesteracrylates, polyurethane-polyacrylates and/or polyacrylates.

These types of dispersion based on polyesters, polyurethanes, polyethers, polyamides, polyvinyl esters, polyvinyl ethers, polysiloxanes, polycarbonates, and/or polyacrylates can also be used as component d), which have functional groups, such as alkoxysilane groups, hydroxy groups and/or, where applicable, isocyanate groups present in blocked form. Thus, dual cure systems can be produced which can be cured by two different mechanisms.

Furthermore component d) can comprise reaction diluents, as was described already under H).

Added photoinitiators e) are initiators activatable by actinic radiation which trigger a radical polymerisation of the corresponding polymerisable groups. Photoinitiators are generally known, commercially sold compounds which differ between unimolecular (Type I) and bimolecular (Type II) initiators. (Type I) systems are, for example, aromatic ketone compounds, for example, benzophenone in combination with tertiary amines, alkylbenzophenones, 4,4′-bis(dimethylamino)benzophenone (michler's ketone), anthrone and halogenated beenzophenones or mixtures of the quoted types. (Type II) initiators are also suitable such as benzoine and its derivatives, benzil ketals, acyl phosphine oxides, for example, 2,4,6-trimethyl-benzoyl-diphenyl phosphine oxide, bis acyl phosphine oxides, phenylglyoxylic acid esters, chinese camphor, α-aminoalkyl phenones, α,α-dialkoxy acetophenores and α-hydroxy alkyl phenones. It may also be advantageous to use mixtures of these compounds. Suitable initiators are commercially available, such as those under the names Irgacure® and Darocura (Ciba, Basel, CH) and Esacure® (Fratelli Lamberti, Adelate, IT).

Stabilisers, light stabilisers such as UV absorbers and sterically hindered amines (HALS), also antioxidants and auxiliary paint substances, for example, antisetting agents, antifoaming- and/or wetting agents, levelling agents, plasticisers, antistatic agents, catalysts, solvents and/or thickeners as well as pigments, colourings and/or matting agents can be used as auxiliary and added substances f) where applicable.

So-called cross-linking agents g) can also be added to the coating material which are intended to improve the drying and, where applicable, the adhesion of the radiation-curable layer.

Preferably, polyisocyanates, polyaziridines and polycarbodiimides are worth considering. Hydrophilated polyisocyanates are particularly preferable for aqueous coating material. The quantity and the functionality of the cross-linking agents has to be determined with particular consideration of the desired ductility of the film. As a general rule, ≤10% w/w of solid cross-linking agents relative to the solids content of the coating agent are used. Many of the possible cross-linking agents reduce the shelf life of the coating agent since they react slowly in the coating material. Therefore, the cross-linking agents should be added correspondingly shortly before the application of the paint on to the film. Hydrophilated polyisocyanates can be obtained, for example, under the names Bayhydur® (Bayer MaterialScience AG, Leverkusen, DE) and Rhodocoat® (Rhodia, F). When adding a cross-linking agent, the time and temperature needed to achieve optimal drying can increase. In a preferable embodiment, no cross-linking agents are used.

Furthermore, a subject matter of the invention is a method for producing coated films, comprising the steps:
I. Preparation of an aqueous radiation-curable coating agent, wherein the aqueous radiation-curable coating material comprises at least one polyurethane (meth)acrylate a), obtainable from the reaction of a reaction mixture comprising:
   A) one or more polyepoxy (meth)acrylates with a hydroxyl value of 20 to 300 mg KOH/g of substance, preferably of 100 to 280 mg KOH/g, particularly preferably 150 to 250 mg KOH/g,
   B) where applicable, different compounds from A) with at least one group reactive to isocyanate and at least one radiation-curable double bond,
   C) one or more linear aliphatic polycarbonate polyols with a hydroxyl value of 25 to 250 mg KOH/g of substance, preferably 35 to 160 mg KOH/g of substance and particularly preferably 50 to 80 mg KOH/g of substance,
   D) where applicable one or more compounds having at least two groups reactive to isocyanate and a molecular weight of less than 300 g/mol, preferably of less than 200 g/mol, particularly preferably of less than 150 g/mol,
   E) one or more compounds with at least one group reactive to isocyanate and additionally at least one group with hydrophilic action,
   F) dicyclohexylmethane 4,4′-diisocyanate,
   G) where applicable, different compounds from A) to F) with at least one amino function,
   H) where applicable, reactive diluents with at least one radically polymerisable group,
and wherein the aqueous coating material furthermore comprises inorganic nanoparticles b) with a mean particle size from ≥1 nm to ≤200 nm, preferably from ≥3 nm to ≤50 nm, particularly preferably from ≥5 nm to ≤20 nm;
2. Coating at least a side of a plastic film with the aqueous coating material from step 1;
3. Drying the coated film.

In the method for producing the films coated according to the invention, the aqueous radiation-curable coating material can contain the other components already quoted above and described in detail.

In one embodiment of the method according to the invention, the aqueous radiation-curable coating material from step 1 can be used as a 20 to 60-%, preferably 30 to 58-% dispersion in water and, where applicable, solvent, and the following components, relative to the solid bodies, comprise:
a) 8.0 to 65.0% w/w, preferably 10.0 to 40.0% w/w, particularly preferably 10.0 to 20.0% w/w of polyurethane (meth)acrylate,
b) 5.0 to 50.0% w/w, preferably 10.0 to 40.0% w/w, particularly preferably 10.0 to 35.0% w/w of inorganic nanoparticles,
c) 0 to 57.0% w/w, preferably 10.0 to 57.0% w/w, particularly preferably 37.0 to 47.0% w/w of polyurethane(meth)acrylate, different from a),
d) 0 to 30% w/w, preferably 0 to 20.0% w/w, particularly preferably 0 to 15% w/w of other binders or reactive diluents,
e) 0.1 to 5.0% w/w, preferably 0.2 to 4.0% w/w, particularly preferably 0.5 to 3.0% w/w of photoinitiators,
f) 0 to 15.0% w/w, preferably 0 to 10.0% w/w, particularly preferably 2.0 to 10.0% w/w of auxiliary and additional substances,
g) 0 to 10% w/w, preferably 0 to 5.0% w/w, particularly preferably 0% w/w of cross-linking agents, wherein the sum of the individual components must add up to 100.

Suitable solvents included where applicable in producing the dispersion are determined based on the binder used as well as the application method. Preferably, water and/or other solvents common in coating technology can be used. Solvents which can be used include acetone, ethyl acetate, butyl acetate, methoxypropyl acetate, diacetone alcohol, glycols, glycol ethers, 1-methoxy-2propanol, xylol or Solventnaphtha from the Exxon-Chemie company as an aromatic solvent as well as mixtures of the quoted solvents.

In producing the polyurethane (meth)acrylate a), all methods known from the prior art can be used, such as the emulsifier-shear force, acetone-, prepolymer mixture-, melt emulsification-, ketimine- and solids spontaneous dispersal methods or derivatives therefrom. A summary of these methods can be found in “Methoden der Organischen Chemie”, Houben-Weyl, 4th Edition, Volume E20/Part 2 on page 1682, Georg Thieme Verlag, Stuttgart, 1987. The melt emulsification method and the acetone method are preferred. Of these the acetone method is the particularly preferable method.

The production of the polyurethane (meth)acrylates a) can be done by reacting the components A) to E) in one or more reaction steps with component F), wherein a polyurethane (meth)acrylate a) is obtained, wherein a neutralising agent can be added before, during or after the production of the addition product from A) to F) to produce the ionic groups needed for the dispersal, followed by a dispersal step where water is added to the addition product of A) to F) or the addition products from A) to F) are transferred into an aqueous receiver, wherein chain elongation can take place by means of component G) before, during or after the dispersal.

Furthermore, in the case of the production as described above, one or more reactive diluents (component H)), containing at least one radically polymeriserable group, is/are added and mixed in.

To produce radiation-curable, aqueous binders based on polyurethane (meth)acrylates a), the components A) to E) are put in the reactor and, where applicable, thinned with acetone. If necessary, component H) can also be added to the components A) to E).

To speed up the reaction, catalysts can be used. These might well include urethanising catalysts familiar as such to the expert, such as tertiary amines or lewis acids. Examples may include tin compounds such as tin octoate, tin acetyl acetonate, tin dichloride or organotin compounds, such as dibutyltin diacetate, dibutyltin dilaurate, dibutyltin bis-acetoacetonate or zinc compounds, such as zinc acetyl acetonate or zinc octoate. The use of lewis acid metallic compounds is also conceivable, which contain molybdenum, vanadium, zirconium, caesium, bismuth or tungsten, such as bismuth(III)octoate. Dibutyltin dilaurate, tin octoate and bismuth(III)octoate are preferred.

Alongside these types of lewis acids, acidic co-agents such as dibutyl phosphate can also be used to adjust the reactivity.

Insofar as it is co-utilised, the catalyst component is used in quantities of 0.001-5.0% w/w, preferably 0.001-0.1% w/w relative to the solids content of the product of the process.

In order to provide stabilisation against premature polymerisation, stabilisers which inhibit the polymerisation can be added as a constituent part of one or more components (A) to F)) before and/or during the reaction. Examples of suitable stabilisers include phenothiazine and phenols such as para-methoxyphenol, 2,5-di-tert-butyl hydroquinone or 2,6-di-tert-butyl-4-methylphenol. Also suitable for stabilising are n-oxyl compounds such as 2,2,6,6-tetramethylpiperidine-n-oxide (TEMPO) or its derivatives. The stabilisers can also be constructed chemically at the same time in the binder, for which compounds the classes quoted above are suitable, particularly if they still hold free aliphatic alcohol groups or primary or secondary amine groups and can therefore be linked chemically to compounds of component F) by means of urethane or urea groups. 2,2,6,6-tetramethyl-4-hydroxy-piperidine-n-oxide is particularly suitable for this.

To stabilise the reaction mixture, particularly avoiding premature polymerisation of the unsaturated groups, an oxygen-containing gas, preferably air, can be introduced by mixing in and/or through the reaction mixture.

If it is co-utilised, the stabilising component is used in quantities of 0.001-5.0% w/w, preferably 0.01-2.0% w/w and particularly preferably 0.05-1.0% w/w relative to the solids content of the product of the process.

Normally, the mixture is heated to 30 to 60° C., to trigger the start of the reaction. Then the dicyclohexylmethane 4,4′-diisocyanate F) is measured in. The reverse is also possible wherein the dicyclohexylmethane 4,4′-diisocyanate F) is introduced and the isocyanate-reactive components A) to E) are added. The addition of the components A) to E) can also be carried out one after the other and in any order. It is also possible to react the components in stages, that is the separate reaction of component F) with one or more isocyanate-reactive components A) to E) before the obtained adduct is reacted further with the components not yet used.

For control of the reaction, the isocyanate content is determined at regular intervals by titration, infrared or near-infrared spectroscopy.

The molar proportions of isocyanate groups in F) to groups reactive to isocyanate in A) to E) are from 0.8:1 to 2.5:1, preferably 12:1 to 1.5:1.

After producing of the polyurethane (meth)acrylate a) from the components A) to F) according to the method described above, if it has not yet been implemented in the starting molecules, salt formation of the dispersal-active groups of component E) is carried out. In the case where component E) contains acidic groups, preferably bases are used selected from the group consisting of triethylamine, ethyldiisopropylamine, dimethylcyclohexylamine, dimethylethanolamine, ammonia, n-ethylmorpholine, LiOH, NaOH and/or KOH. In the case where component E) contains basic groups, preferably acids selected from the group consisting of lactic acid, acetic acid, phosphoric acid, hydrochloric acid and/or sulphuric acid are used. If compounds containing only ether groups are used as component E), this neutralisation step can be omitted.

Next a reactive diluent H) or a mixture reactive diluents H) can be added optionally. The mixing of component H) is done preferably at 30 to 45° C. As soon as it has dissolved, where applicable, the last reaction step follows in which the molecular weight increases in the aqueous medium and the dispersions needed for the inventive coating system are formed: The polyurethane (meth)acrylate a), synthesised from the components A) to F) and, where applicable, the reactive diluent(s) H) are dissolved in acetone, while stirring vigorously either is introduced into the dispersal water containing the amine(s) G), or, conversely, the dispersal water is stirred to obtain the polyurethane acrylate solution. Furthermore, the dispersions are formed which are contained in the inventive coating material. The quantities of amine G) used depend on the unreacted isocyanate groups still remaining. The reaction of the isocyanate groups still free with the amine G) can occur up to 35% to 150%. In the event that a shortfall of amine G) is used, isocyanate groups still free react slowly with water. If an excess of amine G) is used, then no unreacted isocyanate groups will be present, and an aminofunctional polyurethane will be obtained. Preferably, 60% to 110%, particularly preferably 70% to 100% and quite particularly preferably 75% to 90% of the isocyanate groups still free are reacted with the amine G).

In another variant it is possible to perform the increase in molecular weight by the amine G) earlier in an acetonic solution, i.e. before the dispersal, and, where applicable, before or after the addition of the reactive diluent(s) H).

In another variant it is possible to perform the increase in molecular weight by the amine G) after the dispersal step.

Optionally, the reactive diluents H) can also be mixed into the coating material at a later time as component d).

If desired, the organic solvent—if present—can be distilled off. The dispersions will then have a solids content of 20 to 60% w/w, in particular 30 to 58% w/w.

It is also possible to perform the dispersal step in parallel, that is, simultaneously or at least partially simultaneously.

During or immediately after the production of the polyurethane (meth)acrylate a), where applicable, the superficially-modified nanoparticles b) are introduced. This can be done by simply stirring in the particles. However, it is also conceivable to use more power in the dispersal such as by ultrasound, jet dispersing or by high-speed stirrer based on the rotor-stator principle. Simple mechanical stirring is preferred.

The particles can be used principally in powder form as well as in colloidal suspensions or dispersions in suitable solvents. The inorganic nanoparticles are used preferably in colloidal dispersed form in organic solvents (organosols) or particularly preferably in water.

Solvents suitable for the organosols are methanol, ethanol, i-propanol, acetone, 2-butanone, methyl-isobutyl ketone, butyl acetate, ethyl acetate, 1-methoxy-2-propyl acetate, toluene, xylol, 1,4-dioxane, diacetone alcohol, ethylene glycol n-propyl ether or any mixture of these solvents. Suitable organosols have a solids content from ≥10% w/w to ≤60% w/w, preferably ≥15% w/w to ≤50% w/w. Examples of suitable organosols are silicon dioxide organosols, obtainable, for example, under the trade names Organosilicasol® and Suncolloid® (Nissan Chem. Am. Corp.) or under the name Highlink®NanO G (Clariant GmbH).

Insofar as the nanoparticles are used in organic solvents (organosols), they are mixed with the polyurethanes during their production before their dispersal with water. The resulting mixtures are then dispersed by adding water or by transferring into water. The organic solvent of the organosol can be removed optionally before or after the dispersal with water, preferably after the dispersal, by distillation with water.

For the purposes of the present invention, inorganic nanoparticles b) in the form of their aqueous preparations are also used preferably. It is particularly preferable to use inorganic particles in the form of aqueous preparations of superficially-modified, inorganic nanoparticles. These can be modified, for example, before or simultaneously with introduction into the silane modified, polymeric organic binder or in an aqueous dispersion of the silane modified, polymeric organic binder by silanisation.

Preferred aqueous, commercial aqueous nanoparticle dispersions are obtainable under the name Levasil® (H.C. Starck GmbH, Goslar, Germany) and Bindzil® (EKA Chemical AB, Bohus, Sweden). Aqueous dispersions of Bindzil® CC 15, Bindzil® CC 301 and Bindzil® CC 401 from EKA (EKA Chemical AB, Bohus, Sweden) are used particularly preferably.

Insofar as the nanoparticles are used in aqueous form, they can be added to the aqueous dispersions of the polyurethane (meth)acrylates a) and/or c).

In a further embodiment, in the production of the dispersions containing polyurethane (meth)ecrylates, instead of water, the aqueous nanoparticle dispersion preferably diluted further with water is used.

Polyurethane (meth)acrylates c) are obtainable by the normal methods used in polyurethane production, as described already under the production the polyurethane (meth)acrylates a).

The coating of a film with the inventive radiation-curable coating material is done preferably by means of rolling, blade, pouring, spraying or casting. Printing methods, dipping, painting and transfer printing are also possible. The application should be done excluding any radiation which might cause the premature polymerisation of the acrylate and/or methacrylate double bonding of the polyurethane.

The drying of the polymer-dispersion follows the application of the coating agent on to the film. This is accomplished in particular with elevated temperatures in an oven and with moving and, where applicable, also moistened air (convection oven, jet dryer) and thermal radiation (IR, NIR). Furthermore, microwaves may be used. It is possible and advantageous to combine several of these drying methods.

Advantageously, the conditions for drying are selected such that no polymerisation (cross-linking) of the acrylate or methacrylate groups is triggered by the elevated temperature and/or the thermal radiation, since this may impair the ductility. Furthermore, the maximum temperature reached must be purposefully selected low enough that the film is not deformed in an uncontrolled manner.

After the drying/curing step, where applicable after lamination with a protective film on the coating, the coated film can be rolled up. The rolling up can take place without the coating adhering to the reverse side or with the laminating film. However, it is also possible to cut up the coated film and to pass along the cut sections individually or in a stack for further processing.

The present invention also concerns the use of coated films according to the invention for the production of mouldings. The films produced according to the invention are useful materials for producing everyday objects. Thus the film can be used in the production of vehicle attachments, plastic parts such as panels for vehicle interiors and/or aircraft interiors, furniture making, electronic devices, communication devices, housings and decorative objects.

The present invention also concerns a method for producing mouldings with a radiation-cured coating, comprising the steps:
1. Preparation of a coated film according to the present invention,
2. Optional printing, such as by screen printing on the side of the film opposite the coating,
3. Forming the shaped body by thermoforming or high pressure forming,
4. Curing the radiation-curable coating by actinic radiation, preferably UV radiation.

By doing so, the coated film is made into the desired final form by thermal deformation. This can be performed by processes such as deep drawing, vacuum deep drawing, high pressure forming, pressing or blow moulding.

After the deformation step, the coating on the film is finally cured by radiation with actinic radiation, preferably with UV radiation.

Curing with actinic radiation is understood to be the radical polymerisation of ethylenic unsaturated carbon-carbon double bonding by initiator radicals which are released, for example, from the photoinitiators described above by radiating with actinic radiation.

The radiation curing is done preferably by the action of high energy radiation, that is, UV radiation or daylight, for example, light with a wavelength from ≥200 nm to ≤750 nm, or by radiation with high energy electrons (electron radiation, for example, from ≥90 keV to ≤300 keV). The radiation sources used for light or UV light can be, for example, medium or high pressure mercury vapour lamps, wherein the mercury vapour can be modified by doping with other elements such as gallium or iron. Lasers, pulsed lamps (known under the designation UV flash emitters), halogen lamps or excimer radiators can also be used. The radiators can be installed so that they are fixed in position so that the object to be radiated is passed by the radiation source by means of a mechanical device, or the radiator can be movable, and the object to be radiated does not change location during the curing. In UV-curing, the radiation dosage normally adequate for cross-linking falls in the range from ≥80 mJ/cm² to ≤5000 mJ/cm².

Where applicable, the radiation can also be carried out with the exclusion of oxygen, for example, in an inert gas atmosphere or in an oxygen-reduced atmosphere. Preferable inert gases include nitrogen, carbon dioxide, inert gases or flue gases. Furthermore, the radiation can take place with the coating covered with media transparent for the radiation. Examples of this are, for example, plastic films, glass or liquids such as water.

Depending on the radiation dosage and curing conditions, the type and concentration of the initiator used, where applicable, must be varied or, respectively, optimised in a manner familiar for an expert or by relevant testing beforehand. It is particularly advantageous for the curing of the formed films to perform the curing with several radiators, whose disposition is selected such that each point of the coating receives the optimal possible dosage and intensity of radiation for curing. It is particularly important to avoid regions that are not radiated (shadow zones).

Furthermore, depending on the film used, it can be advantageous to select the radiation conditions such that the thermal stress on the film is not too high. In particular, thin films and films from materials with a low glass transition temperature may tend to deform uncontrollably if a certain temperature is exceeded by the radiation. In these cases it is advantageous to allow as little infrared radiation as possible on to the substrate by suitable filters or the construction of the radiators. Furthermore, by reducing the corresponding radiation dosage, the uncontrolled deformation can be counteracted. In doing so, it must be ensured that a certain dosage and intensity are necessary for the most complete polymerisation possible. It is particularly advantageous in these cases to cure under inert or oxygen-reduced conditions since, in reducing the oxygen fraction in the atmosphere above the coating, the dosage required for curing reduces.

For curing, mercury radiators are used particularly preferably in fixed installations. Photoinitiators are then used in concentrations from ≥0.1% w/w to ≤10% w/w, particularly preferably from ≥0.2% w/w to ≤3.0% w/w relative to the solids in the coating. For curing these coatings, a dosage from ≥80 mJ/cm² to ≤5000 mJ/cm², particularly preferably ≥250 mJ/cm² to ≤3000 mJ/cm² is preferably used, wherein the energy can also be introduced in several stages.

The resulting cured, coated, formed film exhibits very good resistance to solvents, colouring liquids typical in the household, as well as excellent hardness, good scratch and abrasion resistance, with high optical transparency and a very high hydrolysis resistance.

In one embodiment, the forming of the moulding is done in a tool at a pressure from ≥20 bar to ≤150 bar. Preferably in this high pressure forming process the pressure falls in a range from ≥50 bar to ≤120 bar or in a range from ≥90 bar to ≤110 bar. The pressure to be used is determined particularly by the thickness of the film being formed and the temperature and the material used for the film.

In another embodiment, the forming of the moulded body takes place at a temperature from ≥20° C. to ≤60° C. below the plasticising temperature of the material of the film. Preferably, this temperature lies at about ≥30° C. to ≤50° C. or about ≥40° C. to ≤45° C. below the plasticising temperature. This process similar to cold forming has the advantage that thinner films can be used, providing more precise moulding. Another advantage is shorter cycle times and lower thermal stressing of the coating. Advantageously, these type of moulding temperatures are used in combination with a high pressure forming process.

In a further embodiment, the method also comprises the step:
5. Application of a polymer, on the side of the film opposite the cured layer.

The moulded coated film, before or preferably after the final curing, can be modified by processes such as back spraying or back foaming with, where applicable, filled polymers such as thermoplastics or also reactive polymers such as two-component polyurethane systems. Here, an adhesive layer can also be used optionally as an adhesive agent. Mouldings are produced which have outstanding usage properties where their surface is formed by the cured coating on the film.

Furthermore, a subject matter of the invention is a moulding which can be produced by a method according to the present invention. These types of moulding can be, for example, vehicle attachments, plastic parts such as panels for vehicle interiors and/or aircraft interiors, furniture making, electronic devices, communication devices, housings and decorative objects.

Below, different embodiments of the invention are described.

In a first embodiment, the film coated according to the invention comprises a plastic film and a radiation-curable aqueous coating material, wherein the coating material comprises at least
a) one polyurethane (meth)acrylate, obtainable from the reaction of a reaction mixture comprising:
   A) one or more polyepoxy (meth)acrylates with a hydroxyl value of 20 to 300 mg KOH/g, preferably of 100 to 280 mg KOH/g, particularly preferably 150 to 250 mg KOH/g of substance,
   B) where applicable, different compounds from A) with at least one group reactive to isocyanate and at least one radiation-curable double bond,
   C) one or more linear aliphatic polycarbonate polyols with a hydroxyl value of 25 to 250 mg KOH/g, preferably 35 to 160 mg KOH/g and particularly preferably 50 to 80 mg KOH/g of substance,
   D) where applicable, one or more compounds having at least two groups reactive to isocyanate and a molecular weight of less than 300 g/mol, preferably of less than 200 g/mol, particularly preferably of less than 150 g/mol,
   E) one or more compounds with at least one group reactive to isocyanate and additionally at least one group with hydrophilic action,
   F) dicyclohexylmethane 4,4′-diisocyanate,
   G) where applicable different compounds from A) to F) with at least one amino function,
   H) where applicable, reactive diluents and
b) inorganic nanoparticles with a mean particle size from ≥1 nm to ≤200 nm, preferably from ≥3 nm to ≤50 nm, particularly preferably from ≥5 nm to ≤20 nm.

In a second embodiment of the coated film according to the above embodiment, the coating material furthermore comprises the following components:
a) 8.0 to 65.0% w/w, preferably 10.0 to 40.0% w/w, particularly preferably 10.0 to 20.0% w/w of polyurethane (meth)acrylate,
b) 5.0 to 50.0% w/w, preferably 10.0 to 40.0% w/w, particularly preferably 15.0 to 35.0% w/w of inorganic nanoparticles,
c) 0 to 57.0% w/w, preferably 10.0 to 57.0% w/w, particularly preferably 37.0 to 47.0% w/w of polyurethane(meth)acylate, different from a),
d) 0 to 30.0% w/w, preferably 0 to 20.0% w/w, particularly preferably 0 to 15.0% w/w, of other binders or reactive diluents,
e) 0.1 to 5.0% w/w, preferably 0.2 to 4.0% w/w, particularly preferably 0.5 to 3.0% w/w, of photoinitiators,
f) 0 to 15.0% w/w, preferably 0 to 10.0% w/w, particularly preferably 2.0 to 10.0% w/w, of auxiliary and additional substances,
g) 0 to 10.0% w/w, preferably 0 to 5.0% w/w, particularly preferably 0% w/w of cross-linking agents,

wherein the quantity data refer to dried film and the sum of the individual components must add up to 100.

In a third embodiment of the coated film according to the above embodiments, c) is contained in an amount of 10.0 to 57.0% w/w.

In a fourth embodiment of the invention according to embodiments described above, c) comprises the components:
B-1) compounds comprising (meth)acrylate groups and reactive to isocyanates,
C-1) where applicable, polyol compounds with a hydroxyl value of 10 mg KOH/g to 500 mg KOH/g, preferably of 28 mg KOH/g to 256 mg KOH/g, particularly preferably of 35 mg KOH/g to 128 mg KOH/g,
D-1) where applicable, polyol compounds with a molecular weight of 50 g/mol to 500 g/mol,
E-1) one or more compounds with at least one group reactive to isocyanates and additionally at least one group with hydrophilic action,
G-1) where applicable, different compounds from B1, D1, E1 with at least one amino function,
F-1) polyisocyanates,
H-1) where applicable, reactive diluents which have at least one radically polymeriserable group.

In a fifth embodiment of the invention according to embodiments described above, c) comprises the following components in a quantity of
B-1): ≥10% w/w to ≤80% w/w, preferably ≥30% w/w to ≤60% w/w, particularly preferably ≥40% w/w to ≤50% w/w.
C-1): ≥0% w/w to ≤50% w/w, preferably 0% w/w to 30% w/w, particularly preferably 0% w/w.
D-1): ≥0% w/w to ≤25% w/w, preferably ≥0.5% w/w to ≤15% w/w, particularly preferably ≥1% w/w to 5% w/w.
E-1): ≥1% w/w to 5 20% w/w, preferably ≥2% w/w to ≤15% w/w, particularly preferably ≥3% w/w to ≤10% w/w.
F-1): ≥5% w/w to ≤50% w/w, preferably ≥20% w/w to ≤40% w/w, particularly preferably ≥25% w/w to ≤35% w/w.
G-1): ≥0% w/w to ≤20% w/w, preferably ≥0.5% w/w to ≤10% w/w, particularly preferably ≥1% w/w to ≤5% w/w.
H-1): ≥0% w/w to ≤40% w/w, preferably ≥5% w/w to ≤30% w/w, particularly preferably ≥5% w/w to ≤25% w/w,

wherein the sum of the individual weight fractions is 100.

In a sixth embodiment of the invention according to the embodiments described above, the plastic for the plastic film is selected from the group consisting of thermoplastic polyurethane, polymethyl methacrylate (PMMA) and modified variants of PMMA, polycarbonate (PC), copolycarbonate, acrylonitrile styrene acrylester copolymerisates (ASA), acrylonitrile butadiene-styrene copolymerisates (ABS) and polybutylene terephthalate/polycarbonate.

In a seventh embodiment of the invention according to the embodiments described above, a reaction product from acrylic acid and/or methacrylic acid with aromatic or aliphatic glycidyl ethers is in the polyurethane (meth)acrylate (a) A), and C) is obtainable by transesterification of diphenyl carbonate, dimethylcarbonate or diethyl carbonate with linear, aliphatic diols, selected from the group consisting of 1,2-ethanediol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol.

In an eighth embodiment of the invention according to the embodiments described above, the surface of the nanoparticles in the coating is modified by the covalent and/or non-covalent linking of other compounds.

In a ninth embodiment of the invention according to the embodiments described above, the nanoparticles are selected from the group consisting of particles of silicon oxide, aluminium oxide, ceroxid, zirconium oxide, niobium oxide and titanium oxide and have a mean particle size from ≥3 nm to ≤50 nm.

In a tenth embodiment of the invention, the method for producing coated films according to embodiments described above comprises the steps
1. Preparation of an aqueous radiation-curable coating agent, wherein the aqueous radiation-curable coating material comprises at least one polyurethane (meth)acrylate a), obtainable from the reaction of a reaction mixture comprising:
   A) one or more polyepoxy (meth)acrylates with a hydroxyl value of 20 to 300 mg KOH/g of substance, preferably of 100 to 280 mg KOH/g, particularly preferably 150 to 250 mg KOH/g,
   B) where applicable, different compounds from A) with at least one group reactive to isocyanate and at least one radiation-curable double bond,
   C) one or more linear aliphatic polycarbonate polyols with a hydroxyl value of 25 to 250 mg KOH/g of substance, preferably 35 to 160 mg KOH/g of substance and particularly preferably 50 to 80 mg KOH/g of substance,
   D) where applicable, one or more compounds having at least two groups reactive to isocyanate and a molecular weight of less than 300 g/mol, preferably of less than 200 g/mol, particularly preferably of less than 150 g/mol,
   E) one or more compounds with at least one group reactive to isocyanate and additionally at least one group with hydrophilic action,
   F) dicyclohexylmethane 4,4′-diisocyanate,
   G) where applicable, different compounds from A) to F) with at least one amino function,
   H) where applicable, reactive diluents with at least one radically polymerisable group,
   and wherein the aqueous coating material furthermore comprises inorganic nanoparticles b) with a mean particle size from ≥1 nm to ≤200 nm, preferably from ≥3 nm to ≤50 nm, particularly preferably from ≥5 nm to ≤20 nm;
2. Coating at least a side of a plastic film with the aqueous coating material from step 1;
3. Drying the coated film.

In an eleventh embodiment of the invention according to the tenth embodiment, the aqueous radiation-curable coating material from step 1 is used as a 20 to 60-%, preferably 30 to 58-% dispersion in water and, where applicable, solvent, and the following components, relative to the solid bodies, comprise:
a) 8.0 to 65.0% w/w, preferably 10.0 to 40.0% w/w, particularly preferably 10.0 to 20.0% w/w of polyurethane (meth)acrylate,
b) 5.0 to 50.0% w/w, preferably 10.0 to 40.0% w/w, particularly preferably 10.0 to 35.0% w/w of inorganic nanoparticles,
c) 0 to 57% w/w, preferably 10.0 to 57.0% w/w, particularly preferably 37.0 to 47% w/w of polyurethane(meth)acrylate, different from a)
d) 0 to 30% w/w, preferably 0 to 20.0% w/w, particularly preferably 0 to 15% w/w of other binders or reactive diluents,
e) 0.1 to 5.0% w/w, preferably 0.2 to 4.0% w/w, particularly preferably 0.5 to 3.0% w/w of photoinitiators
f) 0 to 15.0% w/w, preferably 0 to 10.0% w/w, particularly preferably 2.0 to 10.0% w/w of auxiliary and additional substances,
g) 0 to 10% w/w, preferably 0 to 5.0% w/w, particularly preferably 0% w/w of cross-linking agents,
wherein the sum of the individual components must add up to 100.

In a twelfth embodiment of the invention, the coated films according to embodiments 1 to 9 are used to produce mouldings.

A thirteenth embodiment of the invention comprises a method for producing mouldings with the steps:
1. Preparation of a coated film according to embodiments 1 to 9
2. Optional printing, such as by screen printing, on the side of the film opposite the coating,
3. Forming of the moulding by thermoforming or high pressure forming,
4. Curing the radiation-curable coating by actinic radiation, preferably UV radiation.

A fourteenth embodiment of the invention comprises a method according to the thirteenth embodiment, wherein the forming of the moulding is performed in a tool at a pressure from ≥20 bar to ≤150 bar and at a temperature from ≥20° C. to ≤60° C. below the plasticising temperature of the material of the film.

A fifteenth embodiment of the invention comprises a method according to the thirteenth and fourteenth embodiment, also comprising the step:
5. Application of a polymer to the side of the film opposite the cured layer.

A sixteenth embodiment of the invention comprises a moulding which can be produced by a method according to the thirteenth to the fifteenth embodiment.

A seventeenth embodiment comprises an aqueous binder, obtainable from the reaction of a reaction mixture comprising:
A) one or more polyepoxy (meth)acrylates with a hydroxyl value of 20 to 300 mg KOH/g, preferably of 100 to 280 mg KOH/g, particularly preferably 150 to 250 mg KOH/g of substance,
B) where applicable, different compounds from A) with at least one group reactive to isocyanate and at least one radiation-curable double bond,
C) one or more linear aliphatic polycarbonate polyols with a hydroxyl value of 25 to 250 mg KOH/g, preferably 35 to 160 mg KOH/g and particularly preferably 50 to 80 mg KOH/g of substance,
D) where applicable, one or more compounds having at least two groups reactive to isocyanate and a molecular weight of less than 300 g/mol, preferably of less than 200 g/mol, particularly preferably of less than 150 g/mol,
E) one or more compounds with at least one group reactive to isocyanate and additionally at least one group with hydrophilic action,
F) dicyclohexylmethane 4,4′-diisocyanate,
G) where applicable different compounds from A) to F) with at least one amino function,
H) where applicable, reactive diluents.

An eighteenth embodiment of the invention comprises a coating material, comprising
a) a polyurethane (meth)acrylate according to embodiment seventeen,
b) inorganic nanoparticles with a mean particle size from ≥1 nm to ≤200 nm,
c) where applicable, polyurethane(meth)acrylate, different from a)
d) where applicable, further binders or reactive diluents,
e) photoinitiators,
f) where applicable, auxiliary and additional substances,
g) where applicable, cross-linking agents,

wherein the coating material is present as a 20 to 60-%, preferably 30 to 58-% dispersion in water and, where applicable, solvents are present.

### EXAMPLES

The nco content was monitored in each case by titrimetric analysis according to DIN 53185.

The hydroxyl value was determined according to DIN 53240: titration with 0.1 mol/l meth. KOH solution after cold acetylisation with acetic acid anhydride with dimethylaminopyridine as a catalyst.

The solids content of the polyurethane dispersion was determined gravimetrically after evaporating off all non-volatile constituent parts according to DIN 53216.

The mean particle size was determined by laser correlation spectroscopy.

The outflow time was determined according to DIN 53211 using the 4 mm DIN beaker.

Room temperature was 23° C.

Unless otherwise indicated, the percentage data in the examples are expressed as % w/w.

The following commercial products were used in the examples:
BYK 346: solution of a polyether-modified siloxane (Byk.Chemie)
BYK 333: solution of a polyether-modified siloxane (Byk.Chemie)
Esacure One: photoinitiators (Lamberti)
Tinuvin® 400 DW: light stabilisers (BASF SE)
Bindzil® CC401: nanoparticles (Hedinger GmbH & Co. KG)
Borchi® Gel 0625: non-ionic thickeners based on polyurethanes for aqueous coating material (OMG Borchers GmbH)
Borchi® Kat 24: highly reactive, tin-free catalyst based on metal carboxylate (OMG Borchers GmbH)
Ebecryla 600: bisphenol-a-diglycidyl diacrylate (epoxy acrylate by Alinex Belgium SA with a hydroxyl value of 250 to 260 mg KOH/g determined according to DIN53240)
Photomer® 4399: dipentaerythriol pentaacrylate (BASF SE)
Desmophen® C 2200: linear hydroxyl-terminated aplihatic polycarbonate diol with a mean molecular weight of approx. 2000 g/mol (Covestro Deutschland AG)
Desmophen® C 2100: linear hydroxyl-terminated aplihatic polycarbonate diol with a mean molecular weight of approx. 1000 g/mol (Covestro Deutschland AG)
Desmopheno PEI70HN: linear hydroxyl-terminated aplihatic polyester diol with a mean molecular weight of approx. 1700 g/mol (Covestro Deutschland AG)
Laromer® PE44F: polyester acrylate (BASF SE)
Desmodura W: dicyclohexylmethane 4,4′-diisocyanate (Covestro Deutschland AG)
Desmodura I: isophorone diisocyanate (Covestro Deutschland AG)
Desmodur® H: hexamethylene diisocyanate (Covestro Deutschland AG)
Miramer® M600: reactive diluents (Miwon Speciality Chemical Co. Ltd.)
Bayhydrol® XP2648: aliphatic, polycarbonate-containing anionic polyurethane dispersion, free of solvents (Covestro Deutschland AG)

Production of the Aqueous Radiation-Curable Polyurethane (Meth)Acrylates

PUR Dispersion 1: Production of a Radiation-Curable, Aqueous Polyurethane (Meth)Acrylate a)

220.28 g of Ebecryl® 600 (component A), 550.70 g of Desmophen®C 2200, (component C), 29.54 g of dimethylol propionic acid (component E), 293.81 g of Desmodur® W, (component F), 0.32 g of Borchi®Kat 24 and 0.06 g of dibutyl phosphate were dissolved in 857 g of acetone and reacted to an nco content of 1.18% w/w at 60° C. while stirring. Then, 7.09 g parts of ethylene diamine in 31.5 g of acetone were added to the dispersion while stirring. The neutralisation was then carried out while stirring in 20.06 g of triethylamine. The clear solution was introduced into 1589.2 g of de-ionised water while stirring. Finally the acetone was evaporated out of the dispersion under a low vacuum. A radiation-curable, aqueous polyurethane dispersion with a solids content of 43.1% w/w, an outflow time of 18 sec, a mean particle size of 84 nm and a pH value of 7.9 was obtained.

PUR Dispersion 2: Production of a Radiation-Curable, Aqueous Polyurethane (Meth)Acrylate a)

208.8 g of Ebecryl® 600 (component A), 522.1 g of Desmophene® 2200, (component C), 28.08 g dimethylol propionic acid (component E), 278.6 g of Desmodur® W, (component F), 0.30 g of Borchi®Kat 24 and 0.06 g of dibutyl phosphate were dissolved in 813 g of acetone and reacted to an nco content of 1.07% w/w at 60° C. while stirring. Then, 6.72 g parts of ethylene diamine in 29.8 g of acetone were added to the dispersion while stirring. Then, 186.82 g of Miramer® M600 (component H) was added and the neutralisation was then carried out while stirring in 19.08 g of triethylamine. The clear solution was introduced into 1506.7 g of de-ionised water while stirring. Finally the acetone was evaporated out of the dispersion under a low vacuum. A radiation-curable, aqueous polyurethane dispersion with a solids content of 48.1% w/w, an outflow time of 16 sec, a mean particle size of 136 nm and a pH value of 7.9 was obtained.

PUR Dispersion 3: Production of a Radiation-Curable, Aqueous Polyurethane (Meth)Acrylate a) (not According to the Invention)

95.56 g of Ebecryl® 600 (component A), 238.90 g of Desmophen®C 2200, (component C), 12.81 g dimethylol propionic acid (component E), 107.59 g, of isophorone diisocyanate, (component F), 0.14 g of Borchi®Kat 24 and 0.03 g of dibutyl phosphate were dissolved in 365 g of acetone and reacted to an nco content of 1.30% w/w at 60° C. while stirring. Then, 3.08 g of ethylene diamine in 13.65 g of acetone were added to the dispersion while stirring. Then, 85.48 g of Miramer® M600 (component H) was added and the neutralisation was then carried out while stirring in 19.08 g of triethylamine. The clear solution was introduced into 668.91 g of de-ionised water while stirring. Finally the acetone was evaporated out of the dispersion under a low vacuum. A radiation-curable, aqueous polyurethane dispersion with a solids content of 44.8% w/w, an outflow time of 44 sec, a mean particle size of 246 nm and a pH value of 8.7 was obtained.

PUR Dispersion 4: Production of a Radiation-Curable, Aqueous Polyurethane (Meth)Acrylate a) (not According to the Invention)

223.3 g of Laromer® PE44F (component B), 173.7 g of Desmophen C® 2200 (component C), 14.75 g of dimethylol propionic acid (component E), 108.18 g of Desmodur® W (component F), 0.12 g of Borchi® Kat 24 and 0.02 g of dibutyl phosphate were dissolved in 387.4 g of acetone and reacted to an nco content of 0.7% w/w at 60° C. while stirring. Then, at 45° C., chain extension took place while stirring in 2.78 g of ethylene diamine (dissolved in 11.6 g of acetone), and 72.58 g of Miramer® M600 (component H) were added, followed by neutralisation while stirring in 10.0 g of triethylamine. 695 g of de-ionised water were introduced into the clear solution. Finally the acetone was evaporated out of the dispersion under a low vacuum. A radiation-curable, aqueous polyurethane dispersion with a solids content of 44.6% w/w, an outflow time of 14 sec, a mean particle size of 267 nm and a pH value of 8.4 was obtained.

PUR Dispersion 5: Production of a Radiation-Curable, Aqueous Polyurethane (Meth)Acrylate a) (not According to the Invention, According to EP-A 1489120)

20.85 g of a polyester acrylate with a hydroxyl value of 160 mgKOH/g (produced from 1 mol of adipinic acid, 0.72 mol of trimethylol propane, 1.9 mol of 1.6-hexane diol and 2 mol of acrylic acid), 220.6 g of Desmophen® C 2200 (component C), 70.5 g of a difunctional polypropylene glycol with a hydroxyl value of 56.0 mg KOH/g, 12.21 g of a monofunctional polyalkylene oxide with a molecular weight (Mn) of 2250 g/mol (produced from diethylene glycolmonobutyl ether, propylene oxide and ethylene oxide (in a weight relationship of ethylene oxide to propylene oxide of approx. 5.4:1) (component E), 54.7 g of Desmodur® H (component F), 0.13 g of dibutyl tin dilaurate were dissolved in 633 g of acetone and reacted to an nco content of 1.86% w/w at 60° C. while stirring. Then, at a temperature of 45° C., chain extension took place by adding a solution of 20.23 g of the sodium salt of the 2-aminoethyl-2-aminoethanesulfonic acid (as a 45% solution in water), 1.82 g of ethylene diamine and 0.9 g of hydrazine monohydrate in 89.5 g water. Then a further 475.6 g of water were added and the acetone was evaporated out of the dispersion under a low vacuum. A radiation-curable, aqueous polyurethane dispersion with a solids content of 42.6% w/w, an outflow time of 93 sec, a mean particle size of 134 nm and a pH value of 7.8 was obtained.

PUR Dispersion 6: Production of a Radiation-Curable, Aqueous Polyurethane (Meth)Acrylate a) (not According to the Invention; According to Example 3 in WO2006/101433)

29.9 g of hydroxyethylacrylate, component B), 224.9 g of Desmophen C® 2100 (component C), 17.3 g of trimethylolpropane (component D), 25.9 g of dimethylol propionic acid (component E), 199.7 g of Desmodur® I (component F), 0.30 g of dibutlyl tin dilaurate and 25.4 g of n-methylpyrrolidone were reacted to an nco content of 2.4% w/w at 65° C. while stirring. Then cooled to 40° C., and neutralisation was carried out by adding and stirring in 17.6 g of triethylamine. 1034.7 g of de-ionised water were introduced to the clear solution while stirring. Then, 17.3 g part of ethylene diamine were added to the dispersion while stirring. A radiation-curable, aqueous polyurethane dispersion with a solids content of 35.7% w/w, an outflow time of 13 sec, a mean particle size of 69 nm and a pH value of 8.8 was obtained.

PUR Dispersion 7:

Commercially obtainable Bayhydrol® XP2648

PUR Dispersion 8: Production of a Radiation-Curable Polyurethane (Meth)Acrylate c):

In a reaction vessel with a stirrer, internal thermometer and gas line (air flow 1 l/hr), 471.9 parts of the polyester acrylate Laromer® PE 44 F (component B-1), 8.22 parts of trimethylolpropane (component D), 27.3 parts of dimethylol propionic acid (component E-1), 199.7 parts of Desmodur® W (component F-1), and 0.6 parts of dibutlyl tin dilaurate were dissolved in 220 parts of acetone and reacted to an nco content of 1.47% w/w at 60° C. while stirring. 115.0 parts of the Photomer® 4399 (component H-1) were added to the prepolymer solution thus obtained and stirred in.

It was then cooled to 40° C. and 19.53 g of triethylamine were added. After stirring for 5 minutes at 40° C., the reaction mixture was poured into 1200 g of water at 20° C. while stirring rapidly. Next, 9.32 g of ethylene diamine (component G-1) in 30.0 g water were added.

After 30 min of stirring again, without heating or cooling, the product was distilled in a vacuum (50 mbar, max. 50° C.), to achieve a solids content of 40±1% w/w. The dispersion had a pH value of 8.7 and a mean particle size of 130 nm. The outflow time was 18 sec.

PUR Dispersion 9: Production of a Radiation-Curable, Aqueous Polyurethane (Meth)Acrylate a) (not According to the Invention)

112.08 of Ebecryl® 600 (component A), 238.08 g of Desmophen® PE170HN (non-inventive substitute for component C), 15.0 g of dimethylol propionic acid (component E), 149.4 g of Desmodur® W, (component F) and 0.2 g of Borchi®Kat 24 were dissolved in 280 g of acetone and converted to an nco content of 1.2% w/w at 60° C. while stirring. Then, 3.6 g parts of ethylene diamine in 16.08 g of acetone were added to the dispersion while stirring. Next, neutralisation took place while stirring in 10.7 g triethylamine. The clear solution was introduced into 720.0 g of de-ionised water while stirring. Next, the acetone was evaporated out of the dispersion under a low vacuum. A radiation-curable, aqueous polyurethane dispersion with a solids content of 43.5% w/w, an outflow time of 21 sec, a mean particle size of 100 nm and a pH value of 8.5 was obtained.

Production of the Aqueous Radiation-Curable Coating Agent:

According to the quantity data in Table 1, the polymer dispersions 1-7 were produced while diacetone alcohol and 2-methoxypropanol were added. Esacure® One was added while stirring and then was stirred at 23° C. into a complete solution of Esacure® One. Then, the solution was filtered using a 5 μm bag filter.

The PUR dispersions were added and stirred for 5 min at 500 rpm. While stirring rapidly (1000 rpm) the solution of the Esacure® One produced previously was added within 5 min.

The additives Tinuvin® 400 DW, Byk® 333 and Byk® 346 were added one after the other while stirring (500 rpm), with 5 minutes of stirring each time. The pH value was adjusted to pH 8.0 to 8.5 by adding while stirring (500 rpm). While continuing to stir (500 rpm), Bindzil® CC 401 was added within 10 minutes and stirring continued for another 20 min. If the pH value dropped below 8 during this continued stirring, more n,n-dimethylethylamine was added to restore the pH to 8.0 to 8.5. Borchi® Gel 0625 was dispersed in the solution with the dissolver while stirring rapidly (1000 rpm) and stirring continued for another 30 min at 1000 rpm. Finally, the dispersion was filtered through a 10 μm beg filter.

Application the Polymer Dispersions on Plastic Films

The polymer dispersions 1-7 according to Table 1 were applied with a conventional scraper (nominal wet film thickness of 100 μm) to one side of polycarbonate plastic films (Makrofol® DE1-1, film thicknesses 250 μm and 375 μm, sheet size DIN A4). After a flash-off phase of 10 min at 20° C. to 25° C., the coated films were dried or pre-cross-linked for 10 min at 110° C. in a convection oven. At this stage in the process chain, the coated films thus produced could be handled.

UV Curing of the Coated Plastic Films

In order to be able to assess the properties of the coated films described above, the coating has to be UV cured. The UV curing of the coating was performed with a mercury vapour high pressure lamp of the evo 7 dr type (ssr engineering GmbH, Lippstadt, Germany). The installation is equipped with dicroitic reflectors and quartz plates and has a specific output of 160 W/cm. A UV dosage of 2.0 J/cm² and an intensity of 1.4 W/cm³ was applied. The surface temperature was to reach >70° C.

The data for the UV dosage were evaluated with a Lightbug ILT 490 (International Light Technologies Inc., Peabody Mass., USA). The data for the surface temperature were evaluated with temperature test strips under the brand name RS (order number 285-936; RS components GmbH, Bad Hersfeld, Germany).

Testing the Hydrolysis Resistance

The hydrolysis resistance of the coated and cured films was tested in an environmental chamber. Inspired by Volkswagen AG's TL226, the films were stored standing upright in the vapour phase over a water reservoir. The temperature was maintained at a constant 90° C. and the relative atmospheric humidity at a constant 90%. The storage time varied across a wide range and is stated for the evaluated results in each case in the Tables. The minimum requirement is a lack of damage after 72 hours.

The evaluation of the films was conducted after removal from the environmental chamber immediately after wiping with a soft cloth. The visual appearance of the coating was evaluated. The surface of the coating should not have changed as far as possible.

The coating was tested for adhesion by cross cutting. To do this, a cutting device was used to cut a grid in the coating so that the cuts entered into the barrier layer in the base film. Six cuts were made, parallel to each other and 1 mm apart from each other. Next, another six cuts were made perpendicular to the first so that a square pattern of 25 squares was produced, each with sides 1 mm long. The cut surface was cleaned with a brush to remove dust from the cutting. A piece of duct tape (3M, Scotch) was stuck to the damaged coating surface and rubbed firmly on to the surface so that one end of the adhesive tape remained free for gripping by hand. Then, the adhesive tape was ripped, with sudden movement, from the surface by the free end and the quality of the cut edges in the upper squares was evaluated. Ideally, just straight cut edges would be found without any spalling (=GT0). In order to pass the test, no more than 5% of the coating surface should have been detached at the cut edges (=GT1). Scores greater than GT1 mean that the test was not passed, i.e. the coating was detached from more than 5% of the surface.

TABLE 1
Coating properties and Summary of the polymer dispersions

| | 1 | 2 | 3 (V) | 4 (V) | 5 (V) | 6 (V) | 7 (V) | 8 (V) |
|---|---|---|---|---|---|---|---|---|
| Dispersion | | | | | | | | |
| PUR 8 | 54.6 | 54.6 | 54.6 | 54.6 | 54.6 | 54.6 | 5.46 | 54.6 |
| PUR 1 | 8.7 | | | | | | | |
| PUR 2 | | 8.7 | | | | | | |
| PUR 3 | | | 8.7 | | | | | |
| PUR 4 | | | | 8.7 | | | | |
| PUR 5 | | | | | 8.7 | | | |
| PUR 6 | | | | | | 8.7 | | |
| PUR 7 | | | | | | | 8.7 | |
| PUR 9 | | | | | | | | 8.7 |
| Esacure ® One | 0.7 | 0.7 | 0.7 | 0.7 | 0.7 | 0.7 | 0.7 | 0.7 |
| Diacetone alcohol | 4.9 | 4.9 | 4.9 | 4.9 | 4.9 | 4.9 | 4.9 | 4.9 |
| 2-methoxypropanol | 4.9 | 4.9 | 4.9 | 4.9 | 4.9 | 4.9 | 4.9 | 4.9 |
| Tinuvin ® 400 DW | 2.2 | 2.2 | 2.2 | 2.2 | 2.2 | 2.2 | 2.2 | 2.2 |
| BYK ® 333 | 0.2 | 0.2 | 0.2 | 0.2 | 0.2 | 0.2 | 0 2 | 0.2 |
| BYK ®346 | 0.3 | 0.3 | 0.3 | 0.3 | 0.3 | 0.3 | 0.3 | 0.3 |
| n,n-dimethylethylamine | 0.2 | 0.2 | 0.2 | 0.2 | 0.2 | 0.2 | 0.2 | 0.2 |
| Bindzil ® CC 401 | 23.0 | 23.0 | 23.0 | 23.0 | 23.0 | 23.0 | 23.0 | 23.0 |
| Borchi ® Gel 0625 | 0.3 | 0.3 | 0.3 | 0.3 | 0.3 | 0.3 | 0.3 | 0.3 |
| Hydrolysis resistance | | | | | | | | |
| Adhesion before | GT0 | GT0 | GT0 | GT0 | GT0 | GT0 | GT0 | GT0 |
| hydrolysis | | | | | | | | |
| Hydrolysis 90° C., 90% | | | | | | | | |
| rel. humidity | | | | | | | | |
| After 72 hrs | GT0 | GT0 | GT5 | GT5 | GT5 | GT5 | GT5 | GT5 |
| After 96 hrs | GT1 | GT0 | / | / | / | / | / | / |

The quantity data in the formulation are in % w/w.
V: Comparative example
All PUR dispersions used have a solids content of 40% w/w.

The examples 1 to 8 show that it was only in the use of the PUR dispersions 1 and 2 that a better hydrolysis resistance (at least 72 hrs) was observed in the resulting radiation-curable coating of a plastic film.

The influence of the proportion of a polyurethane (meth)acrylate a) according to the invention in the polymer dispersion on the hydrolysis resistance is shown in Table 2.

TABLE 2
Influence of the proportion by weight of the
dispersions according to the invention

| | 2 | 9 (V) | 10 | 11 | 12 | 13 |
|---|---|---|---|---|---|---|
| Dispersion | | | | | | |
| PUR 8 | 54.6 | 58.3 | 53.3 | 43.3 | 33.3 | |
| PUR 2 | 8.7 | 5.0 | 10.0 | 20.0 | 30.0 | 63.3 |
| Esacure ® One | 0.7 | 0.7 | 0.7 | 0.7 | 0.7 | 0.7 |
| Diacetone alcohol | 4.9 | 4.9 | 4.9 | 4.9 | 4.9 | 4.9 |
| 2-methoxypropanol | 4.9 | 4.9 | 4.9 | 4.9 | 4.9 | 4.9 |
| Tinuvin ® 400 DW | 2.2 | 2.2 | 2.2 | 2.2 | 2.2 | 2.2 |
| BYK ® 333 | 0.2 | 0.2 | 0.2 | 0.2 | 0.2 | 0.2 |
| BYK ®346 | 0.3 | 0.3 | 0.3 | 0.3 | 0.3 | 0.3 |
| n,n-dimethylethylamine | 0.2 | 0.2 | 0.2 | 0.2 | 0.2 | 0.2 |
| Bindzil ® CC 401 | 23.0 | 23.0 | 23.0 | 23.0 | 23.0 | 23.0 |
| Borchi ® Gel 0625 | 0.3 | 0.3 | 0.3 | 0.3 | 0.3 | 0.3 |
| Hydrolysis resistance | | | | | | |
| Adhesion before hydrolysis | GT0 | GT0 | GT0 | GT0 | GT0 | GT0 |
| Hydrolysis 90° C., 90% rel. | | | | | | |
| humidity | | | | | | |
| After 24 hrs | GT0 | GT0 | GT0 | GT0 | GT0 | GT0 |
| After 48 hrs | GT0 | GT0 | GT0 | GT0 | GT0 | GT0 |
| After 72 hrs | GT0 | GT5 | GT0 | GT0 | GT0 | GT0 |
| After 144 hrs | GT1 | GT5 | GT0 | GT0 | GT0 | n.d. |

The quantity data in the formulation are in % w/w.
V: Comparative example
n.d: not determined

When using the PUR 2 particularly advantageously represented according to Table 1, the weight ratio between PUR 8 and PUR 2 was varied.

It is clear, when looking at the adhesion results in Table 2, that a quantity of 5% w/w of PUR 2 is not sufficient in the polymer dispersion to pass the required minimum test duration of 72 hours. By 72 hours, it has lost its adhesion completely.

An additional quantity of 8.7% w/w in the polymer dispersion results in a compound which goes safely beyond the required test conditions and, as a result, has clearly plenty to spare.

The test is passed even after 144 hours with a score of GT1.

Above a proportion of 10% w/w of PUR 2 in the polymer dispersion (Examples 10-13 in Table 2), the hydrolysis test is passed safely even up to 144 hours.

1.-15. (canceled)

16. A coated film, comprising a plastic film and a radiation-curable aqueous coating material, wherein the coating material comprises
a) a polyurethane (meth)acrylate which is obtained from the reaction of a reaction mixture comprising:
A) one or more polyepoxy (meth)acrylates with an OH number of 20 to 300 mg of KOH/g of substance,
B) different compounds from A) with at least one group reactive to isocyanate and at least one radiation-curable double bond,
C) one or more linear aliphatic polycarbonate polyols with a hydroxyl value of 25 to 250 mg KOH/g of substance,
D) optionally, one or more compounds having at least two groups reactive to isocyanate and a molecular weight of less than 300 g/mol,
E) one or more compounds with at least one group reactive to isocyanate and additionally at least one group with hydrophilic action,
F) dicyclohexylmethane 4,4′-diisocyanate,
G) optionally, different compounds from A) to F) with at least one amino function,
H) optionally, reactive diluents, and
b) inorganic nanoparticles with a mean particle size from ≥1 nm to ≤200 nm.

17. The coated film according to claim 16, wherein the coating material furthermore comprises the following
a) 8.0-65.0% of w/w polyurethane (meth)acrylate,
b) 5.0 to 50.0% w/w of inorganic nanoparticles,
c) 0 to 57.0% w/w of polyurethane (meth)acrylate, different from a),
d) 0 to 30.0% w/w of other binders or reactive diluents,
e) 0.1 to 5.0% w/w of photoinitiators,
f) 0 to 15% w/w of auxiliary and additional substances,
g) 0 to 10% w/w of cross-linking agents,
wherein the quantity data refer to dried film and the sum of the individual components does not exceed 100.

18. The coated film according to claim 17, wherein c) is contained in a quantity of 10.0 to 57.0% w/w.

19. The coated film according to claim 16, wherein the plastic for the plastic film is selected from the group consisting of thermoplastic polyurethane, polymethyl methacrylate (PMMA), modified variants of PMMA, polycarbonate (PC), copolycarbonate, acrylonitrile styrene acryl ester-copolymerisates (ASA), acrylonitrile butadiene-styrene copolymerisates (ABS) and polybutylene/terephthalate/polycarbonate.

20. The coated film according to claim 16, wherein in the polyurethane (meth)acrylate a) A) is a reaction product from acrylic acid and/or methacrylic acid with aromatic or aliphatic glycidyl ethers, and C) is obtained by transesterification of diphenyl carbonate, dimethylcarbonate or diethyl carbonate with linear, aliphatic diols, selected from the group consisting of 1,4-butane diol, 1,5-pentane diol, and 1,6-hexane diol.

21. The coated film according to claim 16, wherein the surface of the nanoparticles in the coating is modified by covalent and/or non-covalent linking of other compounds.

22. The coated film according to claim 16, wherein the nanoparticles are selected from the group consisting of particles of silicon oxide, aluminium oxide, ceroxid, zirconium oxide, niobium oxide and titanium oxide and have a mean particle size from ≥3 nm to ≤50 nm.

23. A method for producing the coated film according to claim 16, comprising:
1) preparing an aqueous radiation-curable coating material, wherein the aqueous radiation-curable coating material comprises at least one polyurethane (meth)acrylate a), obtained from the reaction of a reaction mixture comprising:
A) one or more polyepoxy (meth)acrylates with a hydroxyl value of 20 to 300 mg KOH/g of substance,
B) optionally, different compounds from A) with at least one group reactive to isocyanate and at least one radiation-curable double bond,
C) one or more linear aliphatic polycarbonate polyols with a hydroxyl value of 25 to 250 mg KOH/g of substance,
D) optionally, one or more compounds having at least two groups reactive to isocyanate and a molecular weight of less than 300 g/mol,
E) one or more compounds with at least one group reactive to isocyanate and additionally at least one group with hydrophilic action,
F) dicyclohexylmethane 4,4′-diisocyanate and
G) optionally, different compounds from A) to F) with at least one amino function,
H) optionally, reactive diluents,
and wherein the aqueous coating material furthermore comprises inorganic nanoparticles b) with a mean particle size from ≥1 nm to ≤200 nm;
2) coating at least a side of a plastic film with the aqueous coating material from step 1;
3) drying the coated film.

24. The method according to claim 23, wherein the aqueous coating material from step 1 is a 20-60% dispersion in water and, optionally, solvents, and wherein the following components, relative to the solid bodies, comprise:
a) 8.0-65.0% w/w of polyurethane (meth)acrylate,
b) 5.0 to 50.0% w/w of inorganic nanoparticle,
c) 0 to 57% w/w of polyurethane(meth)acrylate, different from a),
d) 0 to 30% w/w of other binders or reactive diluents,
e) 0.1 to 5.0% w/w of photoinitiators,
f) 0 to 15.0% w/w of auxiliary and additional substances,
g) 0 to 10% w/w of cross-linking agents,
wherein the sum of the individual components does not exceed 100.

25. A method for producing moldings comprising utilizing the coated film according to claim 16.

26. A method for producing a moulding, comprising:
1) preparing the coated film according to claim 16,
2) optionally printing, such as by screen printing, on the side of the film opposite the coating,
3) forming the moulding by thermoforming or high pressure forming,
4) curing the radiation-curable coating by actinic radiation.

27. The method according to claim 26, further comprising:
5) applying a polymer to the side of the film opposite the cured layer.

28. A moulding produced by the method according to claim 26.

29. An aqueous binder, obtained from the reaction of a reaction mixture comprising:
A) one or more polyepoxy (meth)acrylates with a hydroxyl value of 20 to 300 mg KOH/g of substance,
B) optionally, different compounds from A) with at least one group reactive to isocyanate and at least one radiation-curable double bond,
C) one or more linear aliphatic polycarbonate polyols with a hydroxyl value of 25 to 250 mg KOH/g of substance,
D) optionally, one or more compounds having at least two groups reactive to isocyanate and a molecular weight of less than 300 g/mol,
E) one or more compounds with at least one group reactive to isocyanate and additionally at least one group with hydrophilic action,
F) dicyclohexylmethane 4,4′-diisocyanate and
G) optionally, different compounds from A) to F) with at least one amino function, and
H) optionally, reactive diluents.

30. A coating material, comprising
a) the aqueous binder according to claim 29,
b) inorganic nanoparticles with a mean particle size from ≥1 nm to ≤200 nm,
c) optionally, polyurethane (meth)acrylate, different from a)
d) optionally, other binders or reactive diluents,
e) photoinitiators,
f) optionally, auxiliary and additional substances,
g) optionally, cross-linking agents,
wherein the coating material is present as a 20 to 60-% dispersion in water and, optionally, solvent.
